(19) United States
(12) Patent Application Publication
(10) Pub. No.: US 2015/0344625 A1
(43) Pub. Date: Dec. 3, 2015

(54) POLYIMIDE FILM, METHOD OF PREPARING POLYIMIDE FILM, OPTICAL DEVICE INCLUDING POLYIMIDE FILM

(71) Applicant: SAMSUNG ELECTRONICS CO., LTD., Suwon-si (KR)

(72) Inventors: Takashi KINO, Yokohama (JP); Hiroshi NAKASHIMA, Hwaseong-si (KR); Chan Jae AHN, Seoul (KR)

(21) Appl. No.: 14/722,636

(22) Filed: May 27, 2015

(30) Foreign Application Priority Data
Jun. 2, 2014 (KR) 10-2014-0067182

(51) Int. Cl. C08G 73/10

(52) U.S. Cl. CPC C08G 73/1067; C08G 73/1007

(57) ABSTRACT

A colorless transparent polyimide having a thickness of about 1 micrometer to about 250 micrometers, an average coefficient of thermal expansion measured in a machine direction and a transverse direction of less than or equal to about 80 parts per million/° C., an average in-plane retardation of less than or equal to about 20 nanometers, an average Yellowness Index of less than or equal to 6, and a transmittance for light at a wavelength of 370 nanometers to 740 nanometers of greater than or equal to about 80%.

### CROSS-REFERENCE TO RELATED APPLICATION

This application claims priority to Korean Patent Application No. 10-2014-0067182, filed on Jun. 2, 2014, and all the benefits accruing therefrom under 35 U.S.C. §119, the content of which is herein incorporated in its entirety by reference.

### BACKGROUND

1. Field

This disclosure relates to a polyimide film, a method of preparing a polyimide film, and a display device including a polyimide film.

2. Description of the Related Art

There is an increasing need for a low energy flexible display, which is light and which delivers various pieces of information by changing to optical information. However, fabrication of a flexible display including manufacture of a flexible substrate, low temperature handling of organic/inorganic materials, flexible electronic parts, and the steps of encapsulating and packaging are complex. Among them, a flexible substrate is an important element, which determines the performance, reliability, and cost of a flexible display.

Plastic substrates are useful as a flexible substrate, as they are useful in a continuous process due to their good processability and lightness. However, plastic substrates have fairly low thermal stability. Thus, properties of the plastic substrates should further be improved.

Therefore, there remains a need for a colorless transparent material having high temperature stability, low coefficient of thermal expansion, high mechanical strength, and low optical anisotropy.

### SUMMARY

An embodiment provides a colorless transparent optical film having a low coefficient of thermal expansion, and a low optical anisotropy.

Another embodiment provides a method of preparing a colorless transparent optical film having a low coefficient of thermal expansion, and a low optical anisotropy.

Yet another embodiment provides an optical device including a colorless transparent optical film having a low coefficient of thermal expansion, and a low optical anisotropy.

According to an embodiment, provided is a colorless transparent polyimide film having:

a thickness of about 1 micrometer to about 250 micrometers,

an average coefficient of thermal expansion in a machine direction and a transverse direction of less than or equal to about 80 parts per million/° C., measured by a thermo-mechanical analyzer, TMA 2940 manufactured by TA Instruments Co., Ltd., at a temperature range of 50° C. to 250° C. by a method including:

heating the film from 25° C. to 260° C. at a heating rate of 10° C./minute, followed by cooling to 40° C. at a cooling rate of 10° C./min, and heating the film from 25° C. to 250° C. at a heating rate of 10° C./minute;

an average in-plane retardation of less than or equal to about 20 nanometers, measured by Axoscan at a wavelength of 550 nanometers throughout the area of the film;

an average Yellowness Index of less than or equal to 6, measured by KONICA MINOLTA CM3600d spectrophotometer; and

a transmittance for light at a wavelength of 370 nanometers to 740 nanometers greater than or equal to about 80%, measured by using CIE standard, Illuminant D65.

The film may include a structure unit represented by Chemical Formula 1, a structure unit represented by Chemical Formula 2, or a combination thereof:

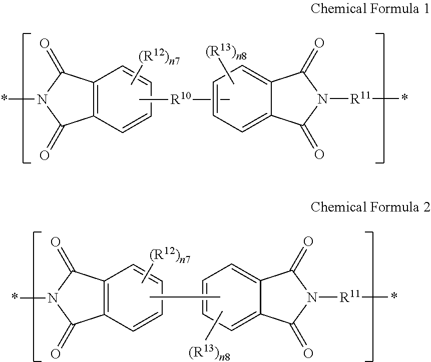

wherein in Chemical Formulae 1 or 2,

R¹⁰ is the same or different in each structure unit, and is independently a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic organic group,

R¹¹ is the same or different in each structure unit, and independently includes a substituted or unsubstituted C6 to C30 aromatic organic group, wherein the aromatic organic group includes one aromatic ring, two or more aromatic rings fused together to provide a condensed ring system, or two or more moieties independently selected from one aromatic ring and two or more aromatic rings fused together to provide a condensed ring system, which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH,

R¹² and R¹³ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n7 and n8 are each independently integers ranging from 0 to 3.

The structure unit represented by Chemical Formula 1 may include a structure unit represented by Chemical Formula 3:

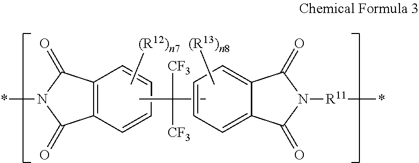

wherein in Chemical Formula 3,

R¹¹, R¹², R¹³, n7, and n8 are the same as in Chemical Formula 1.

In Chemical Formulae 1 and 2, R¹¹ may be represented by Chemical Formula 4, Chemical Formula 5, or Chemical Formula 6:

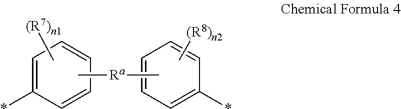

wherein in Chemical Formula 4,

R^{a} may be selected from chemical formulae:

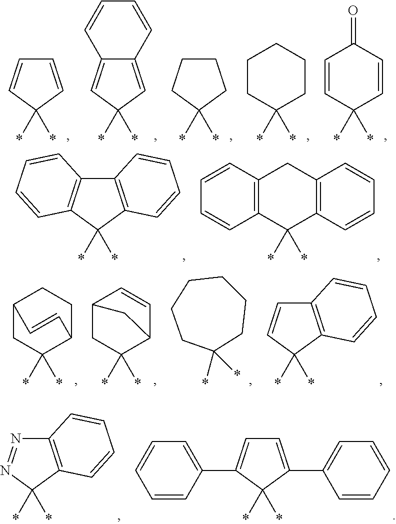

wherein in the chemical formulae,

R⁷ and R⁸ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n1 and n2 are each independently integers ranging from 0 to 4.

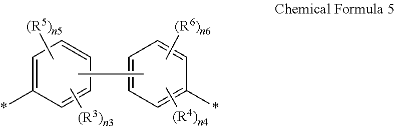

In Chemical Formula 5,

R³ and R⁴ are the same or different, and are independently electron withdrawing groups selected from —CF₃, —CCl₃, —CBr₃, —Cl₃, —NO₂, —CN, —COCH₃, and —CO₂C₂H₅,

R⁵ and R⁶ may be the same or different, and may be independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n3 is an integer ranging from 1 to 4, n5 is an integer ranging from 0 to 3, provided that n3+n5 is an integer ranging from 1 to 4, and

n4 is an integer ranging from 1 to 4, n6 is an integer ranging from 0 to 3, provided that n4+n6 is an integer ranging from 1 to 4.

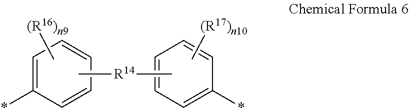

In Chemical Formula 6,

R¹⁴ is O, S, C(═O), CH(OH), S(═O)₂, Si(CH₃)₂, (CH₂)ₚ wherein, 1≦p≦10, (CF₂)_{q} wherein, 1≦q≦10, C(CH₃)₂, C(CF₃)₂, C(═O)NH, or a substituted or unsubstituted C6 to C30 aromatic organic group, wherein the aromatic organic group includes one aromatic ring, two or more aromatic rings fused together to provide a condensed ring system, or two or more moieties independently selected from one aromatic ring and two or more aromatic rings fused together to provide a condensed ring system, which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH,

R¹⁶ and R¹⁷ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n9 and n10 are each independently integers ranging from 0 to 4.

In Chemical Formulae 1 and 2, R¹¹ may be represented by Chemical Formula 7:

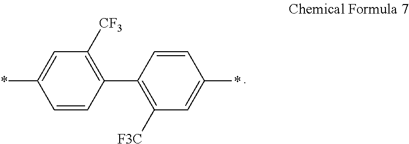 [SMILES: *c1ccc(-c2ccc(*)cc2C(F)(F)F)c(C(F)(F)F)c1]

In Chemical Formulae 1 and 2, both n7 and n8 may be 0.

The film may include a structure unit represented by Chemical Formula 8, a structure unit represented by Chemical Formula 9, or a combination thereof:

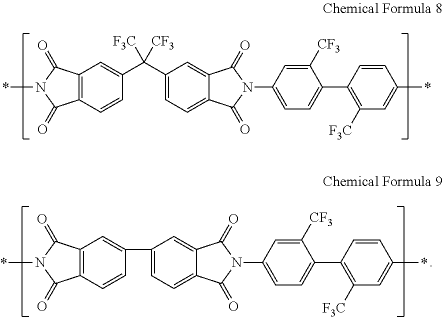

The film may further include at least one of the structure units represented by Chemical Formula 10, Chemical Formula 11, and Chemical Formula 12:

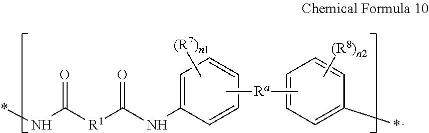

In Chemical Formula 10,

R^{a}, R⁷, R⁸, n1, and n2 are the same as in Chemical Formula 4,

R¹ is the same or different in each structure unit, and is independently a substituted or unsubstituted C6 to C30 aromatic organic group.

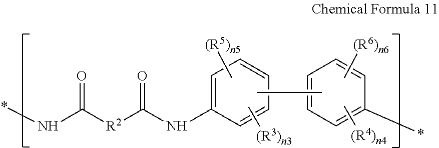

In Chemical Formula 11,

R³, R⁴, R⁵, R⁶, n3, n4, n5, and n6 are the same as described in Chemical Formula 5,

R² is the same or different in each structure unit, and is independently a substituted or unsubstituted C6 to C30 aromatic organic group.

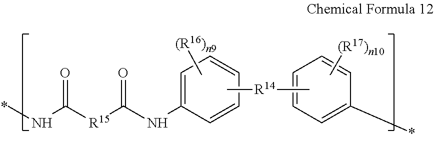

In Chemical Formula 12,

R¹⁴, R¹⁶, R¹⁷, n9, and n10 are the same as in Chemical Formula 6,

R¹⁵ is the same or different in each structure unit, and is independently a substituted or unsubstituted C6 to C30 aromatic organic group.

In Chemical Formulae 10 to 12, R¹, R², and R¹⁵ may be the same or different, and are independently selected from chemical formulae:

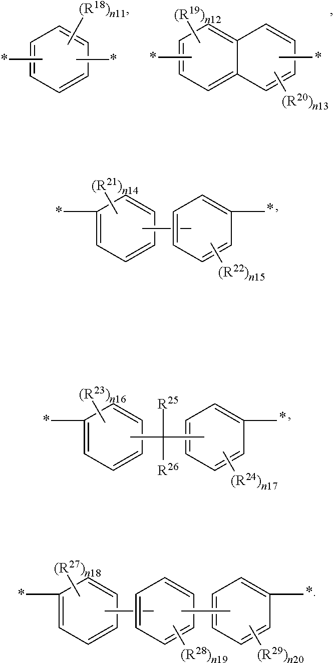

In the chemical formulae,

R¹⁵ to R²⁹ are the same or different, and are independently deuterium, a halogen, a substituted or unsubstituted C1 to C10 aliphatic organic group, or a substituted or unsubstituted C6 to C20 aromatic organic group,

n11 and n14 to n20 are independently integers ranging from 0 to 4, and

n12 and n13 are independently integers ranging from 0 to 3.

For example, R¹, R², and R¹⁵ may be the same or different, and are independently selected from chemical formulae:

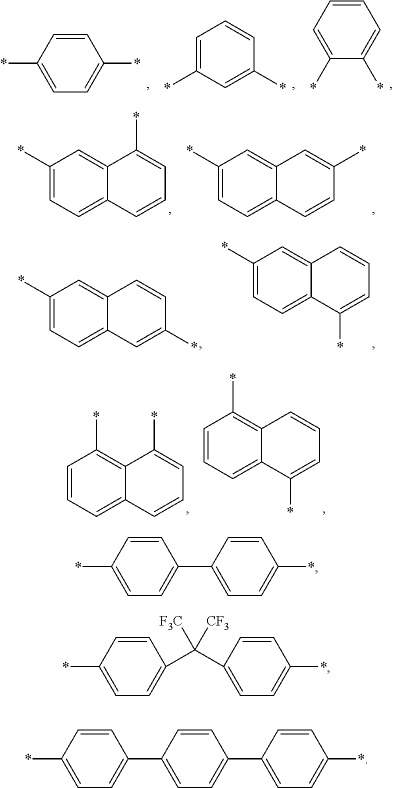

The structure unit represented by Chemical Formula 10 may include a structure unit represented by Chemical Formulae 13, 14 or 15, the structure unit represented by Chemical Formula 11 may include a structure unit represented by Chemical Formulae 16, 17 or 18, the structure unit represented by Chemical Formula 12 may include a structure unit represented by Chemical Formulae 19, 20, or 21:

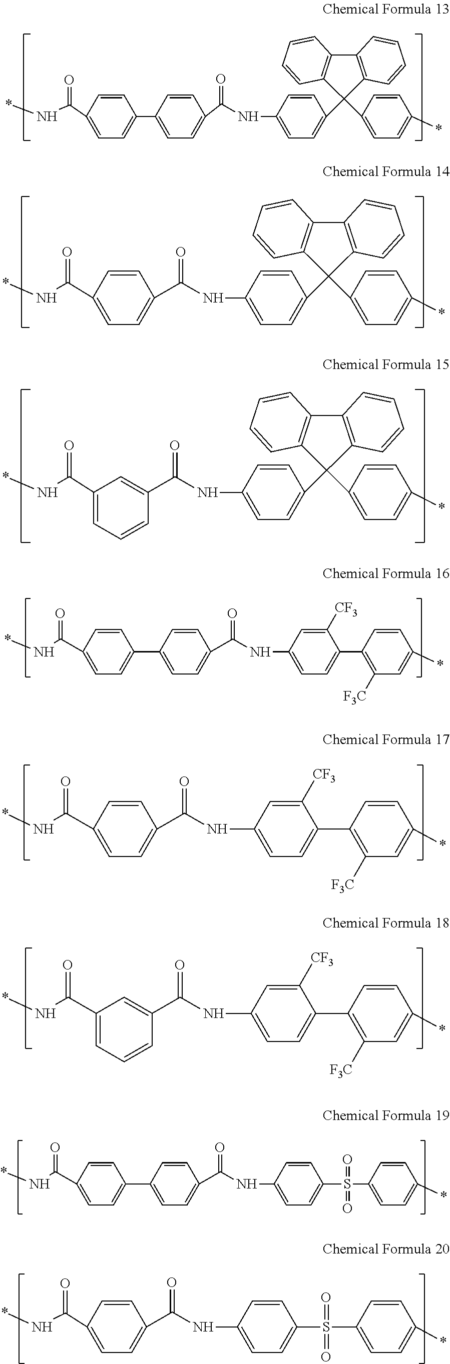

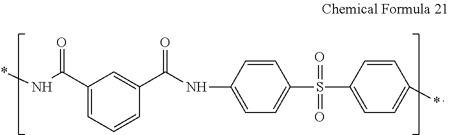

According to another embodiment, provided is a method of preparing a colorless transparent polyimide including:

reacting at least one diamine selected from Chemical Formulae 22 to 24 with at least one dianhydride selected from Chemical Formulae 25 and 26 to provide a polyamic acid solution,

coating the polyamic acid solution on a surface of a polyimide-containing film, and heating to a temperature of less than 300° C. to form a polyamic acid layer on the polyimide-containing film,

heating and curing the polyamic acid layer on the polyimide-containing film to a temperature of less than 500° C. to form a polyimide film, and

separating the obtained polyimide film from the polyimide-containing film:

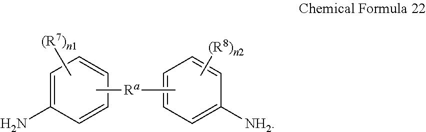

In Chemical Formula 22,

R^{a} may be selected from chemical formulae:

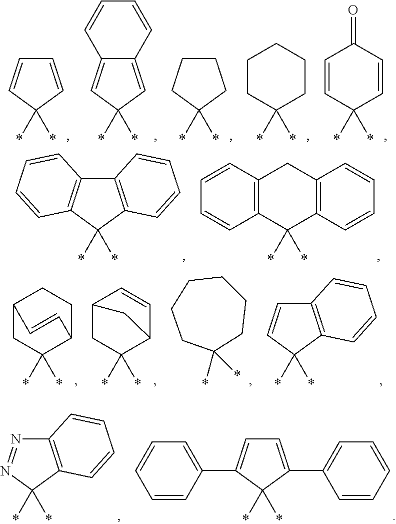

In chemical formulae,

R⁷ and R⁸ may be the same or different, and may be independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n1 and n2 are each independently integers ranging from 0 to 4.

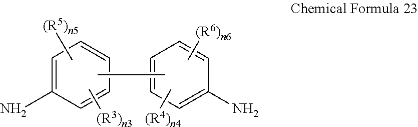

In Chemical Formula 23,

R³ and R⁴ are the same or different, and are independently electron withdrawing groups selected from —CF₃, —CCl₃, —CBr₃, —Cl₃, —NO₂, —CN, —COCH₃, and —CO₂C₂H₅,

R⁵ and R⁶ may be the same or different, and may be independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n3 is an integer ranging from 1 to 4, n5 is an integer ranging from 0 to 3, provided that n3+n5 is an integer ranging from 1 to 4, and

n4 is an integer ranging from 1 to 4, n6 is an integer ranging from 0 to 3, provided that n4+n6 is an integer ranging from 1 to 4.

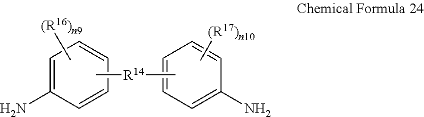

In Chemical Formula 24,

R¹⁴ is O, S, C(═O), CH(OH), S(═O)₂, Si(CH₃)₂, (CH₂)ₚ wherein, 1≦p≦10, (CF₂)_{q} wherein, 1≦q≦10, C(CH₃)₂, C(CF₃)₂, C(═O)NH, or a substituted or unsubstituted C6 to C30 aromatic organic group, wherein the aromatic organic group includes one aromatic ring, two or more aromatic rings fused together to provide a condensed ring system, or two or more moieties independently selected from one aromatic ring and two or more aromatic rings fused together to provide a condensed ring system, which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH,

R¹⁶ and R¹⁷ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n9 and n10 are each independently integers ranging from 0 to 4.

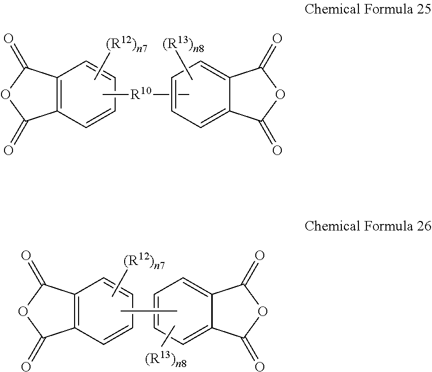

wherein in Chemical Formulae 25 or 26,

R¹⁰ is the same or different in each structure unit, and is independently a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic organic group,

R¹² and R¹³ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n7 and n8 are each independently integers ranging from 0 to 3.

The diamine may be represented by Chemical Formula 23, wherein both R³ and R⁴ may be —CF₃, both n3 and n4 are 1, and both n5 and n6 are 0.

The Chemical Formula 25 may include a structure unit represented by Chemical Formula 27:

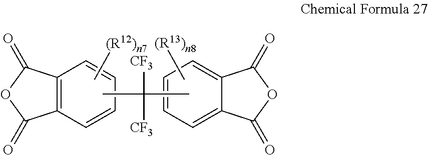

In Chemical Formulae 27 and 25, R¹², R¹³, n7, and n8 are the same as in Chemical Formula 25.

In the polyamic acid solution, the solid content may be about 5 percent by weight to about 30 percent by weight.

The viscosity of the polyamic acid solution may be about 1 poise to about 10,000 poise at 25° C.

The polyamic acid solution may be partially imidized before coating on the surface of a polyimide-containing film.

The polyamic acid solution may further include a structure unit of an amide, which may be a reaction product of a dicarboxylic acid derivative and the diamine. The structure unit of the amide may be represented by at least one of Chemical Formulae 10 to 12.

The glass transition temperature (T_{g}) of the polyimide-containing film may be greater than or equal to the temperature at which the polyamic acid layer is cured to form a polyimide film.

The polyimide-containing film may include a structure unit represented by Chemical Formula 1, a structure unit represented by Chemical Formula 2, or a combination thereof.

The polyimide-containing film may have a thickness of about 1 micrometer to about 1,000 micrometers.

The polyimide-containing film may be UPILEX X film, which is a product of UBE Industries, Ltd.

The polyimide-containing film may extend longitudinally, whereby the polyimide film prepared thereon may be separated from the polyimide-containing film in a roll-to-roll process.

According to another embodiment, provided is an optical device including a colorless transparent polyimide film having a low coefficient of thermal expansion and a low optical anisotropy.

The optical device may include a liquid crystal display (LCD) device, an organic light emitting diode (OLED) device, or a complementary metal-oxide semiconductor (CMOS) device.

According to an embodiment, a colorless transparent polyimide film having a low coefficient of thermal expansion (CTE) and a low optical anisotropy, while maintaining a good heat resistance, chemical resistance, and mechanical strength, and an optical device including the polyimide film are provided.

Hereinafter, further embodiments will be described in detail.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 a graph schematically showing in-plane retardation of a polyimide film prepared by a conventional method in accordance with an embodiment;

FIG. 2 is a cross-sectional view of a liquid crystal display (LCD) in accordance with an embodiment; and

FIG. 3 is a cross-sectional view of an organic light emitting diode (“OLED”) in accordance with an embodiment.

### DETAILED DESCRIPTION

This disclosure will be described more fully hereinafter with reference to the accompanying drawings, in which embodiments are shown. This disclosure may, however, be embodied in many different forms and is not to be construed as limited to the exemplary embodiments set forth herein.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Mixture” as used herein is inclusive of all types of combinations, including blends, alloys, solutions, and the like.

As used herein, when a specific definition is not otherwise provided, the term “substituted” refers to a group or compound substituted with at least one substituent including a halogen (F, Br, CI, or I), a hydroxyl group, a nitro group, a cyano group, an amino group (NH₂, NH(R¹⁰⁰) or N(R¹⁰¹)(R¹⁰²), wherein R¹⁰⁰, R¹⁰¹, and R¹⁰² are the same or different, and are each independently a substituted or unsubstituted C1 to C10 alkyl group, an amidino group, a hydrazine group, a hydrazone group, a carboxyl group, an ester group, a ketone group, a substituted or unsubstituted alkyl group, a substituted or unsubstituted alicyclic organic group, a substituted or unsubstituted aryl group, a substituted or unsubstituted alkenyl group, a substituted or unsubstituted alkynyl group, a substituted or unsubstituted heteroaryl group, and a substituted or unsubstituted heterocyclic organic group, in place of at least one hydrogen of a functional group, or the substituents may be linked to each other to provide a ring.

As used herein, when a specific definition is not otherwise provided, the term “alkyl group” refers to a C1 to C30 alkyl group, for example a C1 to C15 alkyl group, the term “cycloalkyl group” refers to a C3 to C30 cycloalkyl group, for example a C3 to C18 cycloalkyl group, the term “alkoxy group” refer to a C1 to C30 alkoxy group, for example a C1 to C18 alkoxy group, the term “ester group” refers to a C2 to C30 ester group, for example a C2 to C18 ester group, the term “ketone group” refers to a C2 to C30 ketone group, for example a C2 to C18 ketone group, the term “aryl group” refers to a C6 to C30 aryl group, for example a C6 to C18 aryl group, the term “alkenyl group” refers to a C2 to C30 alkenyl group, for example a C2 to C18 alkenyl group, the term “alkynyl group” refers to a C2 to C30 alkynyl group, for example a C2 to C18 alkynyl group, the term “alkylene group” refers to a C1 to C30 alkylene group, for example a C1 to C18 alkylene group, and the term “arylene group” refers to a C6 to C30 arylene group, for example a C6 to C16 arylene group.

As used herein, when a specific definition is not otherwise provided, the term “aliphatic” refers to a C1 to C30 alkyl group, a C2 to C30 alkenyl group, a C2 to C30 alkynyl group, a C1 to C30 alkylene group, a C2 to C30 alkenylene group, or a C2 to C30 alkynylene group, for example a C1 to C15 alkyl group, a C2 to C15 alkenyl group, a C2 to C15 alkynyl group, a C1 to C15 alkylene group, a C2 to C15 alkenylene group, or a C2 to C15 alkynylene group, the term “alicyclic organic group” refers to a C3 to C30 cycloalkyl group, a C3 to C30 cycloalkenyl group, a C3 to C30 cycloalkynyl group, a C3 to C30 cycloalkylene group, a C3 to C30 cycloalkenylene group, or a C3 to C30 cycloalkynylene group, for example C3 to C15 cycloalkyl group, a C3 to C15 cycloalkenyl group, a C3 to C15 cycloalkynyl group, a C3 to C15 cycloalkylene group, a C3 to C15 cycloalkenylene group, or a C3 to C15 cycloalkynylene group.

As used herein when a definition is not otherwise provided, the term “aromatic organic group” refers to a C6 to C30 group comprising one aromatic ring, two or more aromatic rings fused together to provide a condensed ring system, or two or more moieties independently selected from one aromatic ring and two or more aromatic rings fused together to provide a condensed ring system (a single aromatic ring or a condensed ring system), which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH, and specifically through S(═O)₂, for example an aryl group or a C6 to C30 arylene group, specifically a C6 to C16 aryl group or a C6 to C16 arylene group such as phenylene.

As used herein, when a specific definition is not otherwise provided, the term “heterocyclic organic group” refers to a C2 to C30 heterocycloalkyl group, a C2 to C30 heterocycloalkylene group, a C2 to C30 heterocycloalkenyl group, a C2 to C30 heterocycloalkenylene group, a C2 to C30 heterocycloalkynyl group, a C2 to C30 heterocycloalkynylene group, a C2 to C30 heteroaryl group, or a C2 to C30 heteroarylene group including 1 to 3 heteroatoms selected from O, S, N, P, Si, and a combination thereof in one ring, for example a C2 to C15 heterocycloalkyl group, a C2 to C15 heterocycloalkylene group, a C2 to C15 heterocycloalkenyl group, a C2 to C15 heterocycloalkenylene group, a C2 to C15 heterocycloalkynyl group, a C2 to C15 heterocycloalkynylene group, a C2 to C15 heteroaryl group, or a C2 to C15 heteroarylene group including 1 to 3 heteroatoms selected from O, S, N, P, Si, and a combination thereof, in one ring.

As used herein, when a definition is not otherwise provided, “combination” commonly refers to mixing or copolymerization.

In addition, in the specification, the mark “*” may refer to where a point of attachment to another atom or group.

According to an embodiment, provided is a colorless transparent polyimide film having the following properties:
a thickness of from about 1 micrometer (μm) to about 250 μm,
an average coefficient of thermal expansion (CTE) in a machine direction (MD) and a transverse direction (TD) of less than or equal to about 80 parts per million/° C. (ppm/° C.), measured by using a thermo-mechanical analyzer, TMA 2940 (a product of TA Instruments Co., Ltd.), at a temperature range of 50° C. to 250° C. of the film by the method including:

heating the film from 25° C. to 260° C. at a heating rate of 10 degrees Centigrade per minute (° C./min), followed by cooling the film to 40° C. at a cooling rate of 10° C./min, and then heating the film from 25° C. to 250° C. at a heating rate of 10° C./min,
an average in-plane retardation of less than or equal to about 20 nanometers, measured by using Axoscan at a wavelength of 550 nanometers throughout the area of the film,
an average Yellowness Index (YI) of less than or equal to 6, measured by using KONICA MINOLTA CM3600d spectrophotometer, and
a transmittance of greater than or equal to about 80% for light at a wavelength range of 370 nanometers to 740 nanometers, measured by using International Commission on Illumination (CIE) standard, Illuminant D65.

The film may include a structure unit represented by Chemical Formula 1, a structure unit represented by Chemical Formula 2, or a combination thereof:

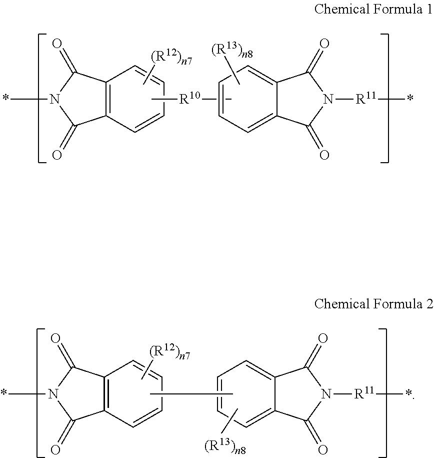

In Chemical Formulae 1 or 2,

R¹⁰ is the same or different in each structure unit, and is independently a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic organic group,

R¹¹ is the same or different in each structure unit, and independently includes a substituted or unsubstituted C6 to C30 aromatic organic group, wherein the aromatic organic group comprises one aromatic ring, two or more aromatic rings fused together to provide a condensed ring system, or two or more moieties independently selected from one aromatic ring and two or more aromatic rings fused together to provide a condensed ring system, which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH,

R¹² and R¹³ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n7 and n8 are each independently integers ranging from 0 to 3.

The structure unit represented by Chemical Formula 1 may include a structure unit represented by Chemical Formula 3:

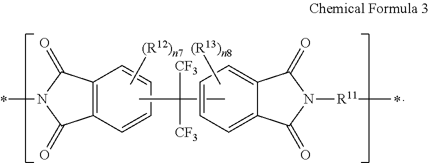

In Chemical Formula 3,

R¹¹, R¹², R¹³, n7, and n8 are the same as described in Chemical Formula 1.

In Chemical Formulae 1 and 2, R¹¹ may be represented by Chemical Formula 4, Chemical Formula 5, or Chemical Formula 6:

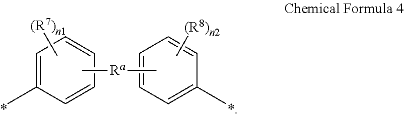

In Chemical Formula 4,

R^{a} may be selected from the following chemical formulae:

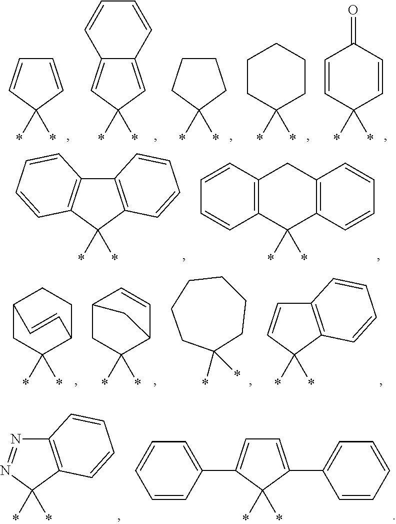

In chemical formulae,

R⁷ and R⁸ may be the same or different, and may be independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R¹¹¹, wherein R²⁰⁹, and R²¹¹ are the same or different, and are independently hydrogen or a substituted or unsubstituted C1 to C10 aliphatic organic group, and

n1 and n2 are each independently integers ranging from 0 to 4.

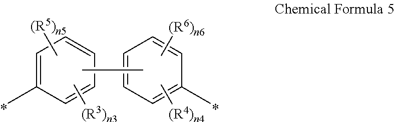

In Chemical Formula 5,

R³ and R⁴ are the same or different, and are independently electron withdrawing groups selected from —CF₃, —CCl₃, —CBr₃, —Cl₃, —NO₂, —CN, —COCH₃, and —CO₂C₂H₅,

R⁵ and R⁶ may be the same or different, and may be independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n3 is an integer ranging from 1 to 4, n5 is an integer ranging from 0 to 3, provided that n3+n5 is an integer ranging from 1 to 4, and

n4 is an integer ranging from 1 to 4, n6 is an integer ranging from 0 to 3, provided that n4+n6 is an integer ranging from 1 to 4.

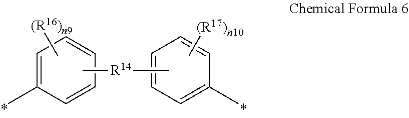

In Chemical Formula 6,

R¹⁴ is O, S, C(═O), CH(OH), S(═O)₂, Si(CH₃)₂, (CH₂)ₚ wherein, 1≦p≦10, (CF₂)_{q} wherein, 1≦q≦10, C(CH₃)₂, C(CF₃)₂, C(═O)NH, or a substituted or unsubstituted C6 to C30 aromatic organic group, wherein the aromatic organic group includes one aromatic ring, two or more aromatic rings fused together to provide a condensed ring system, or two or more moieties independently selected from one aromatic ring and two or more aromatic rings fused together to provide a condensed ring system, which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH,

R¹⁶ and R¹⁷ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n9 and n10 are each independently integers ranging from 0 to 4.

In Chemical Formulae 1 and 2, R¹¹ may be represented by Chemical Formula 7:

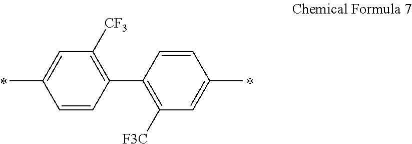

In Chemical Formulae 1 and 2, both n7 and n8 may be 0.

The film may include a structure unit represented by Chemical Formula 8, a structure unit represented by Chemical Formula 9, or a combination thereof:

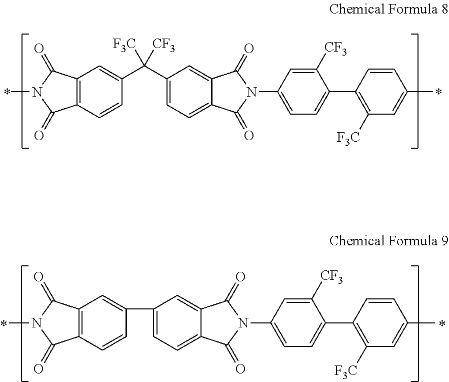

The film may further include at least one of the structure units represented by Chemical Formula 10, Chemical Formula 11, and Chemical Formula 12:

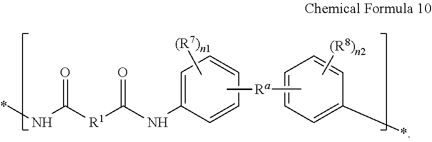

In Chemical Formula 10,

R^{a}, R⁷, R⁸, n1, and n2 are the same as described in Chemical Formula 4, and

R¹ is the same or different in each structure unit, and is independently a substituted or unsubstituted C6 to C30 aromatic organic group.

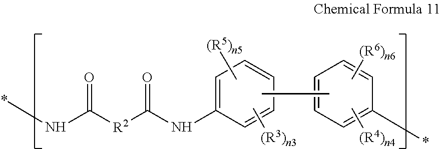

In Chemical Formula 11,

R³, R⁴, R⁵, R⁶, n3, n4, n5, and n6 are the same as described in Chemical Formula 5, and

R² is the same or different in each structure unit, and is independently a substituted or unsubstituted C6 to C30 aromatic organic group.

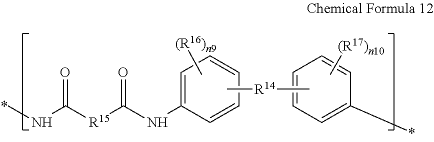

In Chemical Formula 12,

R¹⁴, R¹⁶, R¹⁷, n9, and n10 are the same as described in Chemical Formula 6,

R¹⁵ is the same or different in each structure unit, and is independently a substituted or unsubstituted C6 to C30 aromatic organic group.

In Chemical Formulae 10 to 12, R¹, R², and R¹⁵ may be the same or different, and are independently selected from the following chemical formulae:

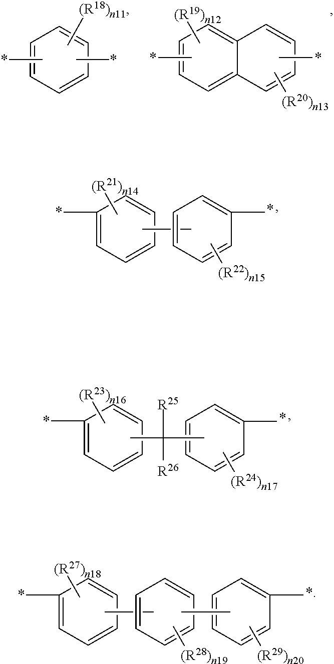

In the above chemical formulae,

R¹⁸ to R²⁹ are the same or different, and are independently deuterium, a halogen, a substituted or unsubstituted C1 to C10 aliphatic organic group, or a substituted or unsubstituted C6 to C20 aromatic organic group,

n11 and n14 to n20 are independently integers ranging from 0 to 4, and

n12 and n13 are independently integers ranging from 0 to 3.

For example, R¹, R², and R¹⁵ may be the same or different, and are independently selected from the following chemical formulae:

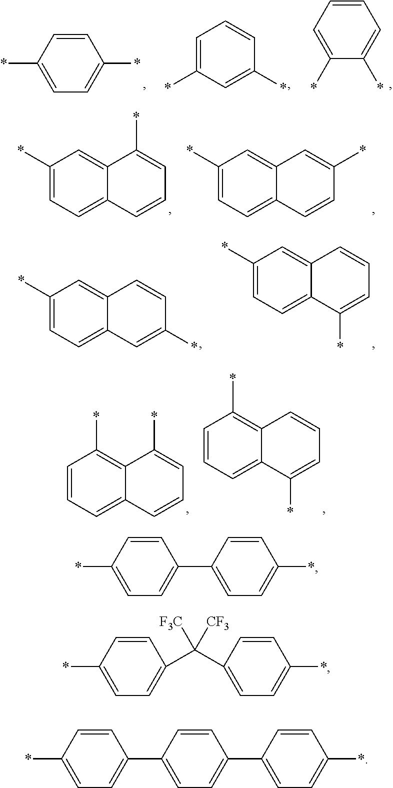

The structure unit represented by Chemical Formula 10 may include a structure unit represented by Chemical Formulae 13, 14 or 15, the structure unit represented by Chemical Formula 11 may include a structure unit represented by Chemical Formulae 16, 17 or 18, the structure unit represented by Chemical Formula 12 may include a structure unit represented by Chemical Formulae 19, 20, or 21:

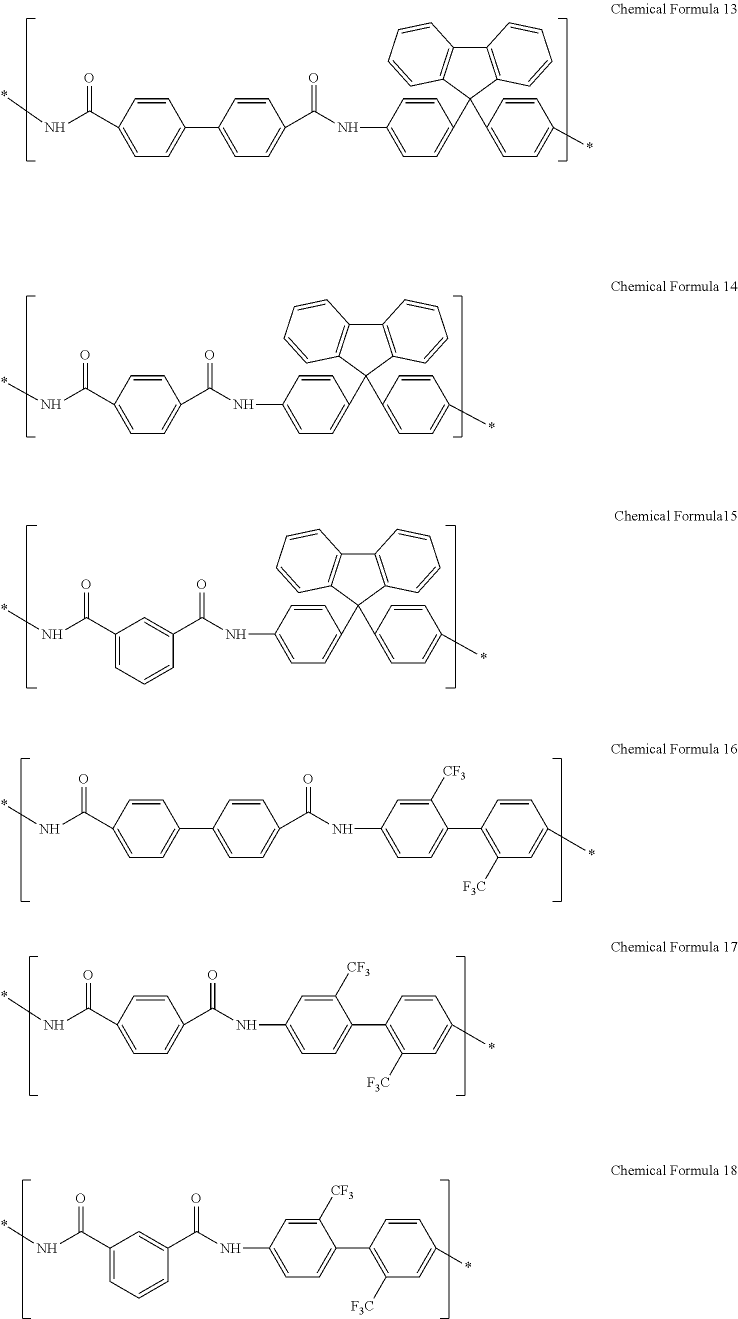

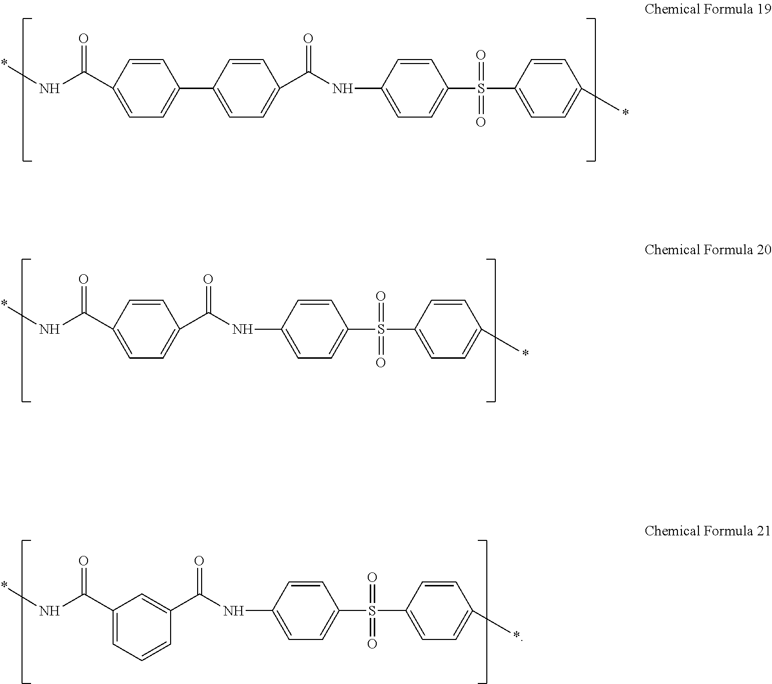

In an exemplary embodiment, the polyimide film may have an average coefficient of thermal expansion (CTE) of less than or equal to about 60 ppm/° C. in an MD and a TD directions of the film, for example, of less than or equal to about 40 ppm/° C., measured by using the thermo-mechanical analyzer, TMA 2940, for the second scanning values at a temperature range from the room temperature (for example, 25° C.) to 250° C.

In an exemplary embodiment, the polyimide film may have an average in-plane retardation of less than or equal to 20 nanometers, for example, of less than or equal to 15 nanometers, for example, of less than or equal to 10 nanometers, measured by using Axoscan for a wavelength of 550 nanometers throughout the area of the film.

To prepare a polyimide film, a tenter method and a cast method may be used.

In the tenter method, a polyamic acid solution is fluidized on a surface of a rotatory drum, a polyamic acid film is separated from the rotatory drum in a gel state, and the polyamic acid film is heated and cured to form a polyimide film in a tenter furnace.

In the cast method, a polyamic acid solution is coated on a substrate, and the substrate is heated to cure the polyamic acid solution to form a polyimide layer. The polyimide layer is then separated from the substrate to form a polyimide film.

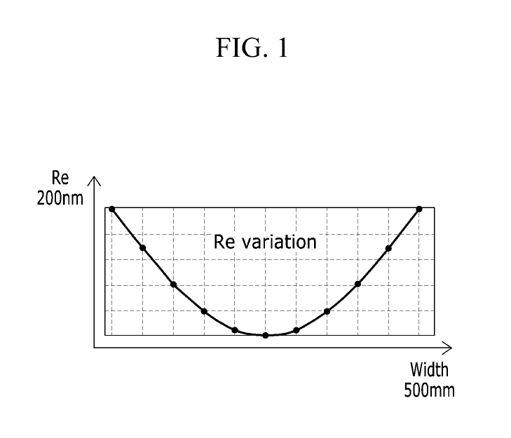

In a conventional tenter method, the rotatory drum is made of stainless steel. When a polyamic acid film separated in a gel state from the rotatory drum is introduced into the tenter furnace, the edges of the film are fixed by clips to form a frame. As a result, the polyamic acid film in a gel state becomes a free standing film, except for the edges fixed by the clips. Meanwhile, the percentages of contraction are different throughout the film, depending on the positions of the film, whether it is supported on a surface of a stainless steel, or whether it is a free standing film. Particularly, the difference in in-plane retardation values between the edges and the inside areas of a film is significant. For example, as shown in FIG. 1, the in-plane retardation of a polyimide film having the width of about 500 millimeters (mm), prepared by conventional tenter method, is the smallest in the center. However, it gradually increases toward the edges of the film, and the difference of the in-plane retardation values of the film between the center and the edges is about 200 nanometer.

In a display device, finding solution to an optical anisotropy problem is an important.

The polyimide film according to the embodiment exhibits a greatly reduced in-plane retardation (Rₑ), while maintaining excellent heat resistance, chemical resistance, and mechanical strength, which are advantageous properties that make the polyimide film suitable for use in an optical device, such as, for example, a flexible display device. Particularly, the polyimide film according to an embodiment, which includes a described specific structure unit, is colorless and transparent. The polyimide film according to the embodiment also has a low coefficient of thermal expansion (CTE). These properties are advantageous for carrying out a process of fabricating an optical device under high temperature.

As described in the Examples and Comparative examples, a polyimide film according to an embodiment has a substantially low average value of in-plane retardation of 10 nanometers (nm). In contrast, in-plane retardation of the conventional polyimide films is known to be at least about 70 nm to about 200 nm or greater.

While not wishing to be bound by a specific theory, it is understood that the low in-plane retardation of a polyimide film according to an embodiment may be accomplished by including a specific structure unit. Further, the low in-plane retardation of the polyimide film may be obtained by preparing the film on a polyimide-containing film, i.e., by a method including:

coating a polyamic acid solution on a polyimide-containing film, and

heating and curing a polyamic acid layer obtained from the polyamic acid solution on the polyimide-containing film to form a polyimide film on the polyimide-containing film.

Accordingly, yet another embodiment provides a method of preparing a colorless transparent polyimide film including:

reacting at least one diamine selected from Chemical Formulae 22 to 24 with at least one dianhydride selected from Chemical Formulae 25 and 26 to provide a polyamic acid solution,

coating the polyamic acid solution on a surface of a polyimide-containing film, and heating to a temperature of less than 300° C. to form a polyamic acid layer on the polyimide-containing film,

heating and curing the polyamic acid layer on the polyimide-containing film to a temperature of less than 500° C. to form a polyimide film, and

separating the obtained polyimide film from the polyimide-containing film:

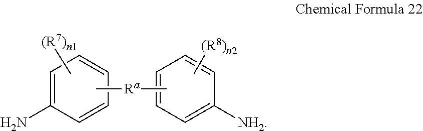

In Chemical Formula 22,

R^{a} may be selected from the following chemical formulae:

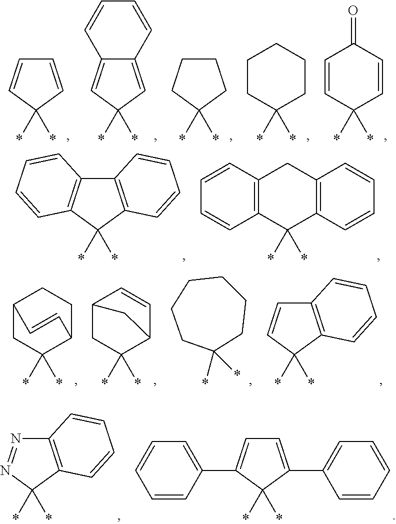

In chemical formulae,

R⁷ and R⁸ may be the same or different, and may be independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n1 and n2 are each independently integers ranging from 0 to 4.

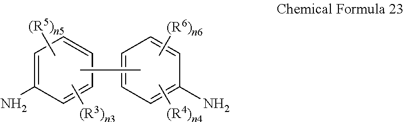

In Chemical Formula 23,

R³ and R⁴ are the same or different, and are independently electron withdrawing groups selected from —CF₃, —CCl₃, —CBr₃, —Cl₃, —NO₂, —CN, —COCH₃, and —CO₂C₂H₅.

R⁵ and R⁶ may be the same or different, and may be independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n3 is an integer ranging from 1 to 4, n5 is an integer ranging from 0 to 3, provided that n3+n5 is an integer ranging from 1 to 4, and

n4 is an integer ranging from 1 to 4, n6 is an integer ranging from 0 to 3, provided that n4+n6 is an integer ranging from 1 to 4.

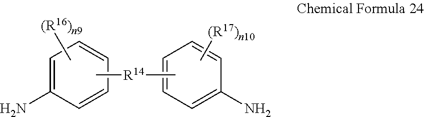

In Chemical Formula 24,

R¹⁴ is O, S, C(═O), CH(OH), S(═O)₂, Si(CH₃)₂, (CH₂)ₚ wherein, 1≦p≦10, (CF₂)_{q} wherein, 1≦q≦10, C(CH₃)₂, C(CF₃)₂, C(═O)NH, or a substituted or unsubstituted C6 to C30 aromatic organic group, wherein the aromatic organic group comprises one aromatic ring, two or more aromatic rings fused together to provide a condensed ring system, or two or more moieties independently selected from one aromatic ring and two or more aromatic rings fused together to provide a condensed ring system, which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH,

R¹⁶ and R¹⁷ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n9 and n10 are each independently integers ranging from 0 to 4.

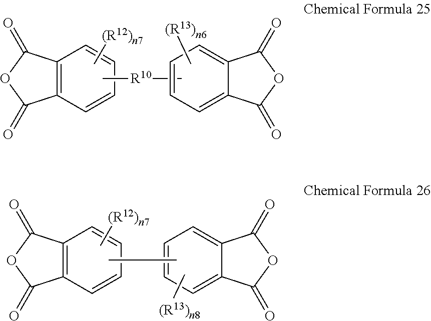

In Chemical Formulae 25 or 26,

R¹⁰ is the same or different in each structure unit, and is independently a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic organic group,

R¹² and R¹³ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and

n7 and n8 are each independently integers ranging from 0 to 3.

The diamine may be represented by Chemical Formula 23, wherein both R³ and R⁴ may be —CF₃, both n3 and n4 are 1, and both n5 and n6 are 0.

The Chemical Formula 25 may include a structure unit represented by Chemical Formula 27:

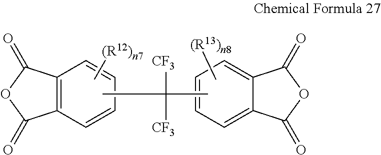

In Chemical Formulae 27 and 25, both n7 and n8 may be 0.

In the polyamic acid solution, the solid content may be about 5 percent by weight (wt %) to about 30 wt %.

The viscosity of the polyamic acid solution may be about 1 poise to about 10,000 poise at 25° C.

Within the ranges of the solid content and viscosity, the polyamic acid solution can be readily coated on a polyimide-containing film, and high viscosity of the polyamic acid solution may be prevented.

The polyamic acid solution may be partially imidized before coating on the surface of a polyimide-containing film. Spontaneous imidization may occur in a polyamic acid solution, while it is stored at room temperature. However, polyamic acid may also reversibly decompose, causing reduction in the molecular weight of the polymer to be used for the film, which may cause unsatisfactory properties of the prepared film. Accordingly, to prevent the reduction of molecular weight of the polyamic acid in the process, the polyamic acid solution may be partially imidized by carrying out chemical or thermal imidization.

During chemical imidization of the polyamic acid solution, a chemical imidization agent may be included in the polyamic acid solution in an amount of less than 100 mol %, for example from about 0.01 mol % to about 99.9 mol %, for example from about 10 mol % to about 90 mol %, based on the total mole number of the amic acid contained in the polyamic acid. The amount of the chemical imidization agent is not limited to the above ranges, and a person skilled in the art can use an appropriate amount of the imidization agent, considering the properties of the film or the conditions of the process.

The chemical imidization agent may be selected from an alkyl anhydride, aryl anhydride, and a combination thereof, but is not limited thereto.

The polyamic acid solution may further include a structure unit of an amide, which is the reaction product of a dicarboxylic acid derivative and the diamine. The structure unit of the amide may be represented by Chemical Formulae 10, 11, 12, or a combination thereof.

The polyimide-containing film may include a structure unit represented by Chemical Formula 2.

The thickness of the polyimide-containing film may range from about 1 micrometers (μm) to about 1,000 μm, for example, from about 10 μm to about 500 μm, for example, from about 20 μm to about 200 μm. Within the above ranges of thickness, the polyimide film prepared on the surface of the polyimide-containing film from the polyamic acid solution coated on the surface of the polyimide-containing film may have a reduced in-plane retardation. As described in the following Examples, within the thickness range of about 20 μm to about 130 μm, the thicker the polyimide-containing film, the smaller the in-plane retardation of the polyimide prepared. While not wishing to be bound by a specific theory, it is believed that the thicker the polyimide-containing film, the more stably and the more uniformly the polyimide-containing film supports the polyimide film prepared thereon, whereby the percentage of in-plane contraction of the polyimide film may be uniformly maintained.

The polyimide-containing film may be UPILEX S film manufactured by UBE INDUSTRIES LTD. It is known that the adhesive strength of UPILEX S film is not very strong, thus it is believed that UPILEX S film is advantageous for the polyimide film prepared on a surface of UPILEX S to be easily separated from UPILEX S.

However, the polyimide-containing film is not limited to UPILEX S, and any polyimide-containing film may be used as a polyimide-containing film substrate, provided that the polyimide-containing film has a glass transition temperature (T_{g}) higher than or equal to the temperature at which a polyamic acid layer is cured to a polyimide film and a polyimide film prepared on the surface thereof is capable of peeling off readily from the polyimide-containing film.

The polyimide-containing film may longitudinally extend, in such a way that a polyimide film prepared on the surface of the polyimide-containing film may be separated from the polyimide-containing film in a roll-to-roll method.

Thus, the method according to an embodiment may be a combination of the conventional tenter and cast methods for preparing a polyimide film. That is, the method may include a cast process in one aspect, according to which a polyamic acid solution is casted on a polyimide-containing film, and is cured to a polyimide film while being on a surface of the polyimide-containing film. Meanwhile, the polyimide-containing film may longitudinally extend to be suitable for a roll-to-roll process, whereby the polyimide-containing film may be formed as a belt, the polyamic acid layer may be introduced into a tenter furnace while being maintained on a surface of the polyimide-containing film, and a polyimide film prepared in the tenter furnace may exit the tenter furnace before being separated from the polyimide-containing film. In this aspect, the process may also belong to a tenter process.

According to the method of the embodiment, a half-dried polyamic acid film may not be separated from a rotatory drum prior to a placement into a tenter furnace, and can be continuously processed on a surface of a polyimide-containing film from the start to end of a process. Therefore, it is possible to prevent the reduction of production and ineffectiveness of process due to the breakage of a polyamic acid film, which may take place when the film is separated it from the rotatory drum. Thus, a polyimide film may be obtained more efficiently.

According to yet another embodiment, provided is an optical device including a colorless transparent polyimide film having a low coefficient of thermal expansion and a low optical anisotropy.

The optical device may include a liquid crystal display (LCD) device, an organic light emitting diode (OLED) device, or a complementary metal-oxide semiconductor (CMOS) device.

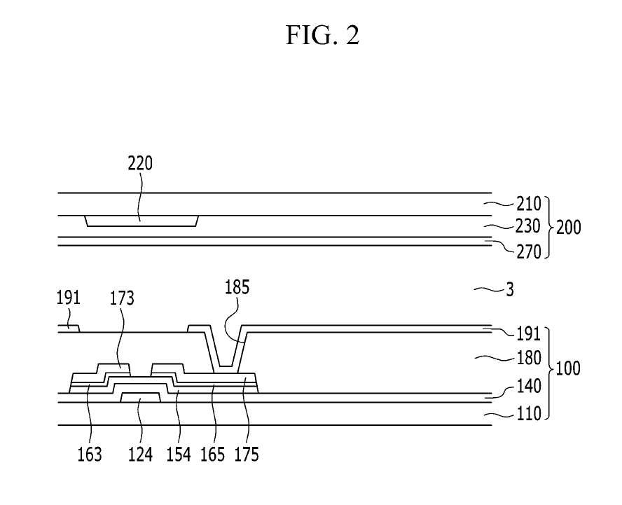

Among the display devices, a liquid crystal display (LCD) is described by referring to FIG. 2. FIG. 2 is a cross-sectional view of a liquid crystal display (LCD) in accordance with an embodiment.

Referring to FIG. 2, the liquid crystal display (LCD) includes a thin film transistor array panel 100, a common electrode panel 200 facing the thin film transistor array panel 100, and a liquid crystal layer 3 interposed between the two panels 100 and 200.

First, the thin film transistor array panel 100 will be described.

A gate electrode 124, a gate insulating layer 140, a semiconductor 154, a plurality of ohmic contacts 163 and 165, a source electrode 173 and a drain electrode 175 are sequentially disposed on a substrate 110. The source electrode 173 and the drain electrode 175 are isolated from each other and face each other with the gate electrode 124 disposed between them.

One gate electrode 124, one source electrode 173, and one drain electrode 175 constitute one thin film transistor (TFT) together with the semiconductor 154, and a channel of the thin film transistor is formed in the semiconductor 154 disposed between the source electrode 173 and the drain electrode 175.

A protective layer 180 is disposed on the gate insulating layer 140, the source electrode 173, and the drain electrode 175, and a contact hole 185 that exposes the drain electrode 175 is formed in the protective layer 180.

A pixel electrode 191 formed of a transparent conductive material such as indium tin oxide (ITO) or indium zinc oxide (IZO) is disposed on the protective layer 180. The pixel electrode 191 is connected to the drain electrode 175 through the contact hole 185.

The common electrode panel 200 will now be described.

In the common electrode panel 200, a lighting member 220 referred to as a black matrix is disposed on a substrate 210, a color filter 230 is disposed on the substrate 210, and the lighting member 220, and a common electrode 270 is formed on the color filter 230.

Herein, the substrates 110 and 210 may be articles including the composite including the poly(amide-imide) copolymer and inorganic particles.

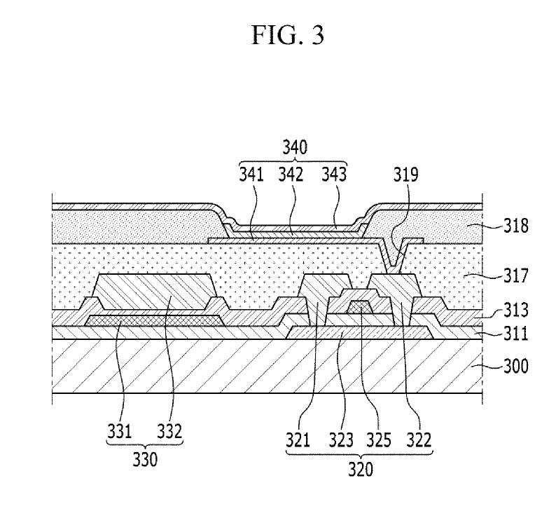

Among the display devices, an organic light emitting diode (OLED) is described by referring to FIG. 3. FIG. 3 is a cross-sectional view of an organic light emitting diode (OLED) in accordance with an embodiment.

Referring to FIG. 3, a thin film transistor 320, a capacitor 330, and an organic light emitting element 340 are formed on a substrate 300. The thin film transistor 320 includes a source electrode 321, a semiconductor layer 323, a gate electrode 325, and a drain electrode 322, and the capacitor 330 includes a first capacitor 331 and a second capacitor 332. The organic light emitting element 340 includes a pixel electrode 341, an intermediate layer 342, and an opposed electrode 343.

According to an embodiment, the semiconductor layer 323, a gate insulating layer 311, the first capacitor 331, the gate electrode 325, an interlayer insulating layer 313, the second capacitor 332, the source electrode 321, and the drain electrode 322 are formed on the substrate 300. The source electrode 321 and the drain electrode 322 are isolated from each other, while facing each other with the gate electrode 325 disposed between them.

A planarization layer 317 is disposed on the interlayer insulating layer 313, the second capacitor 332, the source electrode 321, and the drain electrode 322. The planarization layer 317 includes a contact hole 319 that exposes the drain electrode 322.

The pixel electrode 341 formed of a transparent conductive material such as ITO or IZO is disposed on the planarization layer 317. The pixel electrode 341 is connected to the drain electrode 322 through the contact hole 319.

The intermediate layer 342 and the opposed electrode 343 are sequentially disposed on the pixel electrode 341.

A pixel defining layer 318 is formed on a portion where the pixel electrode 341, the intermediate layer 342, and the opposed electrode 343 are not formed on the planarization layer 317.

Herein, the substrate 300 may be formed into an article including the composite including the poly(amide-imide) copolymer and inorganic particles.

Hereafter, the technology of this disclosure is described in detail with reference to examples. The following examples and comparative examples are not restrictive but are illustrative.

### EXAMPLES

### Synthesis Example 1

### Synthesis of a Partially Imidized Colorless Polyamic Acid Solution

0.025 moles (mole) of 3,3′,4,4′-biphenyltetracarboxylic dianhydride (sBPDA), 0.025 mole of 4,4′-(hexafluoroisopropylidene)diphthalic anhydride (6FDA), and 0.05 mole of 2,2′-bis(trifluoromethyl)benzidine (TFDB) are dried in a vacuum at 100° C. overnight. Dimethylacetamide (DMAc) is added into a N₂ gas purged 500 milliliter (mL) round bottomed flask in an amount in which solid content becomes 10 percent by weight (wt %). The dried TFDB is then added to the flask and the mixture is agitated in one direction at 100 revolutions per minute (rpm) for 30 minutes at 10° C. until the solid is dissolved. In order for the remaining solid TFDB at the center of the bottom of the flask to be completely dissolved, more agitation in one direction at 300 rpm for 30 minutes at 10° C. is performed. Then, the BPDA is added at once, and the resulting mixture is agitated in one direction at 100 rpm for 30 minutes at 10° C. The rate of agitation is then increased to 300 rpm, and more agitation in one direction for 24 hours is performed. The 6FDA is then added and the resulting mixture is agitated in one direction at 100 rpm for 30 minutes at 10° C. More agitation in one direction at 300 rpm for 30 minutes is then performed to completely dissolve the 6FDA. The agitation is continued in both directions at 100 rpm for 24 hours.

In order for the unreacted monomers, which are present due to uneven mixing resulting from high viscosity of the reaction mixture, to be further polymerized, more DMAc is added to dilute the reaction mixture and to control the degree of polymerization.

After then, 80 mole percent (mol %) of acetic anhydride, and 80 mol % of pyridine, based on the total mole number of the imide functional groups, are added to the reaction product. The mixture is then agitated in both directions for 12 hours at 25° C. to obtain a colorless polyamic acid solution which is 80% chemically imidized. The reaction product is stored in a refrigerator for viscosity stability.

### Synthesis Example 2

### Synthesis of a Partially Imidized Colorless Polyamic Acid Solution

0.04 mole of 3,3′,4,4′-biphenyltetracarboxylic dianhydride (sBPDA), 0.01 mole of 4,4′-(hexafluoroisopropylidene)diphthalic anhydride (6FDA), and 0.05 mole of 2,2′-bis(trifluoromethyl)benzidine (TFDB) are dried in a vacuum at 100° C. overnight. Dimethylacetamide (DMAc) is added into a N₂ gas purged 500 mL round bottomed flask in such amount that an amount of solid content is 10 wt %. Then the dried TFDB is added to the flask and the mixture is agitated in one direction at 100 rpm for 30 minutes at 10° C. until dissolved. In order for the unsolved TFDB at the center of the bottom to completely dissolved, more agitation in one direction at 300 rpm for 30 minutes at 10° C. is performed. Then, the BPDA is added at once, and the resulting mixture is agitated in one direction at 100 rpm for 30 minutes at 10° C. The rate of agitation is then increased to 300 rpm, and more agitation for 24 hours in one direction is performed. Then, the 6FDA is added and the mixture is agitated in one direction at 100 rpm for 30 minutes at 10° C. More agitation in one direction at 300 rpm for 30 minutes is then performed to completely dissolve the 6FDA. and the reaction mixture is then further agitated in both direction at 100 rpm for 24 hours.

In order for the unreacted monomers, which are present due to uneven mixing resulting from high viscosity of the reaction mixture, to be further polymerized, more DMAc is added to dilute the reaction mixture and to control the degree of the polymerization.

Subsequently, 60 mol % of acetic anhydride, and 60 mol % of pyridine, based on the total mole number of the imide functional groups, are added to the reaction product, and the mixture is agitated in both directions for 12 hours at 25° C. to obtain a colorless polyamic acid solution which is 60% chemically imidized. The reaction product is stored in a refrigerator for viscosity stability.

### Synthesis Example 3

### Synthesis of a Partially Imidized Colorless Polyamic Acid Solution

0.05 mole of 3,3′,4,4′-biphenyltetracarboxylic dianhydride (sBPDA), 0.05 mole of 4,4′-(hexafluoroisopropylidene)diphthalic anhydride (6FDA), and 0.05 mole of 2,2′-bis(trifluoromethyl)benzidine (TFDB) are dried in a vacuum at 100° C. overnight. Dimethylacetamide (DMAc) is added into a N₂ gas purged 500 mL round bottomed flask in such an amount that an amount of solid content is 10 wt %. The dried TFDB is then added to the flask and agitated in one direction at 100 rpm for 30 minutes to be solved at 10° C. In order for the unsolved TFDB at the center of the bottom to completely dissolved, more agitation in one direction at 300 rpm for 30 minutes at 10° C. is performed. Then, the BPDA is added at one time, and the resulting mixture is agitated in one direction at 100 rpm for 30 minutes at 10° C. The rate of agitation is then increased to 300 rpm, and more agitation for 24 hours in one direction is performed. The 6FDA is then added and the resulting mixture is agitated in one direction at 100 rpm for 30 minutes at 10° C. More agitation in one direction at 300 rpm for 30 minutes is then performed to completely dissolve the 6FDA. Subsequently, the reaction mixture is agitated in both directions at 100 rpm for 24 hours.

In order for the unreacted monomers, present due to uneven mixing resulting from high viscosity of the reaction mixture, to be further polymerized, more DMAc is added to dilute the reaction mixture and control the degree of the polymerization.

Subsequently, 30 mol % of acetic anhydride, and 30 mol % of pyridine, based on the total mole number of the imide functional groups, are added to the reaction product, and the mixture is agitated in both directions for 12 hours at 25° C. to obtain a colorless polyamic acid solution which is 30% chemically imidized. The reaction product is stored in a refrigerator for viscosity stability.

### Preparation Example 1

### Preparation of a Polyimide Film on a Polyimide-Containing Film

Each of the partially imidized polyamic acid solutions prepared according to Synthesis Examples 1 to 3 is coated on Upilex S (UBE Industries Ltd.) in a thickness of 25 μm, as a substrate, and is heated and cured by steps at 130° C., 180° C., 250° C., and 350° C., to form a polyimide film. The polyimide films formed on the Upilex S substrate are respectively separated from the substrate.

### Preparation Example 2

### Preparation of a Polyimide Film on a Polyimide-Containing Film

Polyimide films are prepared by the same method as in Preparation Example 1, except that Upilex S (UBE Industries Ltd.) having a thickness of 38 μm, instead of 25 μm, is used as a substrate. That is, each of the partially imidized polyamic acid solutions according to Synthesis Examples 1 to 3 is coated on Upilex S (UBE Industries Ltd.) having a thickness of 38 μm to form a polyimide film.

### Preparation Example 3

### Preparation of a Polyimide Film on a Polyimide-Containing Film

Polyimide films are prepared by the same method as described in Preparation Example 1, except that Upilex S (UBE Industries Ltd.) having a thickness of 50 μm, instead of 25 μm, is used as a substrate. That is, each of the partially imidized polyamic acid solutions prepared according to Synthesis Examples 1 to 3 is coated on Upilex S (UBE Industries Ltd.) having a thickness of 50 μm to form a polyimide film.

### Preparation Example 4

### Preparation of a Polyimide Film on a Polyimide-Containing Film

Polyimide films are prepared in the same method as in Preparation Example 1, except that Upilex S (UBE Industries Ltd.) having a thickness of 75 μm, instead of 25 μm, is used as a substrate. That is, each of the partially imidized polyamic acid solutions prepared according to Synthesis Examples 1 to 3 is coated on Upilex S (UBE Industries Ltd.) having a thickness of 75 μm to form a polyimide film.

### Preparation Example 5

### Preparation of a Polyimide Film on a Polyimide-Containing Film

Polyimide films are prepared by the same method as in Preparation Example 1, except that Upilex S (UBE Industries Ltd.) having a thickness of 125 μm, instead of 25 μm, is used as a substrate. That is, each of the partially imidized polyamic acid solutions prepared according to Synthesis Examples 1 to 3 is coated on Upilex S (UBE Industries Ltd.) having a thickness of 125 μm to form a polyimide film.

### Preparation Example 6

### Preparation of a Polyimide Film on a Stainless Steel Substrate

Each of the partially imidized polyamic acid solutions prepared according to Synthesis Examples 1 to 3 is coated on a stainless steel substrate, and is dried for 10 minutes at 130° C. The resulting half-dried self-supporting films are separated from the stainless steel substrates, and fixed by metal pin frames, respectively, to be heated and cured at 160° C. for 10 minutes, 190° C. for 10 minutes, 250° C. for 10 minutes, and 350° C. for 10 minutes, to form polyimide films.

### Examples 1 to 5

### Preparation of a Polyimide Film of Thickness of 25 μm Using the Polyamic Acid Solution of Synthesis Example 1

Polyimide films having thickness of 25 μm are prepared from the polyamic acid solution prepared in Synthesis Example 1, which is 80% imidized, by the methods disclosed in Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 1 below.

### Examples 6 to 10

### Preparation of a Polyimide Film of Thickness of 50 μm Using the Polyamic Acid Solution of Synthesis Example 1

Polyimide films having thickness of 50 μm are prepared from the polyamic acid solution prepared in Synthesis Example 1, which is 80% imidized, by the methods disclosed in Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 1 below.

### Examples 11 to 15

### Preparation of a Polyimide Film of Thickness of 75 μm Using the Polyamic Acid Solution of Synthesis Example 1

Polyimide films having thickness of 75 μm are prepared from the polyamic acid solution prepared according to Synthesis Example 1, which is 80% imidized, by the methods described in Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 1 below.

### Examples 16 to 20

### Preparation of a Polyimide Film of Thickness of 100 μm Using the Polyamic Acid Solution of Synthesis Example 1

Polyimide films having thickness of 100 μm are prepared from the polyamic acid solution prepared in Synthesis Example 1, which is 80% imidized, by the methods according to Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 1 below.

### Examples 21 to 25

### Preparation of a Polyimide Film of Thickness of 25 μm Using the Polyamic Acid Solution of Synthesis Example 2

Polyimide films having thickness of 25 μm are prepared from the polyamic acid solution prepared in Synthesis Example 2, which is 60% imidized, by the methods according to Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 2 below.

### Examples 26 to 30

### Preparation of a Polyimide Film of Thickness of 50 μm Using the Polyamic Acid Solution of Synthesis Example 2

Polyimide films having thickness of 50 μm are prepared from the polyamic acid solution prepared in Synthesis Example 2, which is 60% imidized, by the methods according to Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 2 below.

### Examples 31 to 35

### Preparation of a Polyimide Film of Thickness of 75 μm Using the Polyamic Acid Solution of Synthesis Example 2

Polyimide films having thickness of 75 μm are prepared from the polyamic acid solution prepared in Synthesis Example 2, which is 60% imidized, by the methods according to Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 2 below.

### Examples 36 to 40

### Preparation of a Polyimide Film of Thickness of 100 μm Using the Polyamic Acid Solution of Synthesis Example 2

Polyimide films of thickness of 100 μm are prepared from the polyamic acid solution prepared in Synthesis Example 2, which is 60% imidized, by the methods according to Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 2 below.

### Examples 41 to 45

### Preparation of a polyimide film of thickness of 25 μm Using the Polyamic Acid Solution of Synthesis Example 3

Polyimide films having thickness of 25 μm are prepared from the polyamic acid solution prepared in Synthesis Example 3, which is 30% imidized, by the methods according to Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 3 below.

### Examples 46 to 50

### Preparation of a Polyimide Film of Thickness of 50 μm Using the Polyamic Acid Solution of Synthesis Example 3

Polyimide films having thickness of 50 μm are prepared from the polyamic acid solution prepared in Synthesis Example 3, which is 30% imidized, by the methods according to Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 3 below.

### Examples 51 to 55

### Preparation of a Polyimide Film of Thickness of 75 μm Using the Polyamic Acid Solution of Synthesis Example 3

Polyimide films having thickness of 75 μm are prepared from the polyamic acid solution prepared in Synthesis Example 3, which is 30% imidized, by the methods according to Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 3 below.

### Examples 56 to 60

### Preparation of a Polyimide Film of Thickness of 100 μm Using the Polyamic Acid Solution of Synthesis Example 3

Polyimide films having thickness of 100 μm are prepared from the polyamic acid solution prepared in Synthesis Example 3, which is 30% imidized, by the methods according to Preparation Examples 1 to 5. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 3 below.

### Comparative Examples 1 to 4

### Preparation of Polyimide Films of Thicknesses of 25 μm to 100 μm Using the Polyamic Acid Solution of Synthesis Example 1

Polyimide films having thicknesses of 25 μm, 50 μm, 75 μm, and 100 μm are prepared from the polyamic acid solution prepared in Synthesis Example 1, which is 80% imidized, by the method according to Preparation Example 6. The properties of the obtained polyimide films, such as, the composition of the films, thickness of the films and substrates, coefficient of thermal expansion, in-plane retardation (Rₑ), Y(D65), Yellowness Index (Y. I.), etc., are summarized in Table 4 below.

### Comparative Examples 5 to 8

### Preparation of Polyimide Films of Thicknesses of 25 μm to 100 μm Using the Polyamic Acid Solution of Synthesis Example 2

Polyimide films having thicknesses of 25 μm, 50 μm, 75 μm, and 100 μm are prepared from the polyamic acid solution prepared in Synthesis Example 2, which is 60% imidized, by the method according to Preparation Example 6. The properties of the obtained polyimide films, such as, the composition of the films, thickness of the films and substrates, coefficient of thermal expansion, in-plane retardation in-plans (Rₑ), Y(D65), Yellowness Index (Y. I.), etc., are summarized in Table 4 below.

### Comparative Examples 9 to 12

### Preparation of Polyimide Films of Thicknesses of 25 μm to 100 μm Using the Polyamic Acid Solution of Synthesis Example 3

Polyimide films having thicknesses of 25 μm, 50 μm, 75 μm, and 100 μm are prepared from the polyamic acid solution prepared in Synthesis Example 3, which is 30% imidized, by the method according to Preparation Example 6. The properties of the obtained polyimide films, such as, the composition of the films, thickness of the films and substrates, coefficient of thermal expansion (CTE), in-plane retardation (Rₑ), Y(D65), Yellowness Index (Y. I.), etc., are summarized in Table 4 below.

Results

The properties of the polyimides films according to Examples 1 to 60 and Comparative Examples 1 to 12, such as, the compositions of the films, thickness of the films, thickness of the substrate, CTE, Rₑ, Y(D65), and Yellowness Index (Y. I.), etc., are summarized in Tables 1 to 4 below. These properties are determined as follows:

Coefficient of Thermal Expansion (CTE): CTE is measured using a thermo-mechanical analyzer (TMA), TMA 2940 (TA Instruments, USA), which is pre-loaded at 10 milliNewton (mN), 5° C. per minute, according to the following heating program. Specifically, the CTE measurement takes a second scan value, which is measured at a temperature ranging from 50° C. to 250° C.

First scan condition: maintain the same temperature for 5 minutes→increase the temperature up to 400° C. at a speed of 10° C./min→cool down to 40° C.

Second scan condition: increase a temperature up to 300° C. at a speed of 10° C./min.

In-plane retardation (Rₑ): Rₑ is measured at the edges and at the centers of the samples of 30 centimeters (cm)×30 cm by using Axoscan.

YI and Y(D650): YI and transmittance of the films are measured for the light at a wavelength range of 360 nanometers to 740 nanometers by using a spectrophotometer CM3600d (Konica Minolta), and Y(D650) is calculated by using D65 standard method.

TABLE 1

| | | Thickness | | | | |
|---|---|---|---|---|---|---|
| | Thickness | of polyimide | | | | |
| | of films | substrate | CTE | Rₑ | | Y |
| Examples | (μm) | (μm) | (ppm/° C.) | (nm) | Y.I. | (D65) |
| 1 | 25 | 25 | 45 | 6 | 0.8 | 90 |
| 2 | 25 | 38 | 42 | 7 | 1.2 | 90 |
| 3 | 25 | 50 | 40 | 5 | 1.4 | 90 |
| 4 | 25 | 75 | 45 | 6 | 1 | 90 |
| 5 | 50 | 100 | 43 | 6 | 1 | 90 |
| 6 | 50 | 25 | 45 | 4 | 1.3 | 90 |
| 7 | 50 | 38 | 47 | 3 | 1.5 | 90 |
| 8 | 50 | 50 | 48 | 2 | 1 | 90 |
| 9 | 50 | 75 | 50 | 4 | 1.2 | 90 |
| 10 | 50 | 100 | 48 | 3 | 1.5 | 90 |
| 11 | 75 | 25 | 50 | 3 | 2 | 90 |
| 12 | 75 | 38 | 53 | 4 | 1.8 | 90 |
| 13 | 75 | 50 | 51 | 2 | 1.6 | 90 |
| 14 | 75 | 75 | 55 | 2 | 1.9 | 90 |
| 15 | 75 | 100 | 53 | 5 | 1.5 | 90 |
| 16 | 100 | 25 | 60 | 1 | 1.5 | 90 |
| 17 | 100 | 38 | 57 | 1 | 2 | 90 |
| 18 | 100 | 50 | 55 | 3 | 1.8 | 90 |
| 19 | 100 | 75 | 58 | 2 | 1.9 | 90 |
| 20 | 100 | 100 | 60 | 2 | 1.6 | 90 |

TABLE 2

| | | Thickness | | | | |
|---|---|---|---|---|---|---|
| | Thickness | of polyimide | | | | |
| | of films | substrate | CTE | Re | | Y |
| Example | (μm) | (μm) | (ppm/° C.) | (nm) | Y.I. | (D65) |
| 21 | 25 | 25 | 30 | 8 | 2.5 | 88 |
| 22 | 25 | 38 | 32 | 6 | 2.8 | 88 |
| 23 | 25 | 50 | 35 | 7 | 2.3 | 88 |
| 24 | 25 | 75 | 34 | 7 | 3 | 87 |
| 25 | 50 | 100 | 32 | 7 | 2.5 | 88 |
| 26 | 50 | 25 | 35 | 7 | 3 | 87 |
| 27 | 50 | 38 | 38 | 6 | 3.2 | 88 |
| 28 | 50 | 50 | 40 | 6 | 3.5 | 87 |
| 29 | 50 | 75 | 40 | 5 | 2.5 | 87 |
| 30 | 50 | 100 | 35 | 6 | 3 | 88 |
| 31 | 75 | 25 | 42 | 4 | 3.5 | 88 |
| 32 | 75 | 38 | 45 | 5 | 3.2 | 88 |
| 33 | 75 | 50 | 42 | 4 | 3.4 | 87 |
| 34 | 75 | 75 | 40 | 5 | 3 | 87 |
| 35 | 75 | 100 | 41 | 5 | 3.2 | 87 |
| 36 | 100 | 25 | 45 | 5 | 3.8 | 87 |
| 37 | 100 | 38 | 48 | 4 | 4 | 87 |
| 38 | 100 | 50 | 50 | 4 | 3.5 | 87 |
| 39 | 100 | 75 | 47 | 5 | 3.4 | 87 |
| 40 | 100 | 100 | 45 | 3 | 3.7 | 87 |

TABLE 3

| | | Thickness | | | | |
|---|---|---|---|---|---|---|
| | Thickness | of polyimide | | | | |
| | of films | substrate | CTE | Re | | Y |
| Example | (μm) | (μm) | (ppm/° C.) | (nm) | Y.I. | (D65) |
| 41 | 25 | 25 | 23 | 10 | 3 | 85 |
| 42 | 25 | 38 | 20 | 10 | 3.2 | 85 |
| 43 | 25 | 50 | 25 | 9 | 3.5 | 86 |
| 44 | 25 | 75 | 22 | 9 | 3.1 | 85 |
| 45 | 50 | 100 | 25 | 10 | 3 | 84 |
| 46 | 50 | 25 | 30 | 8 | 3.5 | 86 |
| 47 | 50 | 38 | 28 | 7 | 3.5 | 86 |
| 48 | 50 | 50 | 25 | 8 | 3.8 | 86 |
| 49 | 50 | 75 | 30 | 9 | 3.9 | 86 |
| 50 | 50 | 100 | 28 | 8 | 4 | 85 |
| 51 | 75 | 25 | 32 | 7 | 4.2 | 85 |
| 52 | 75 | 38 | 35 | 6 | 4.5 | 86 |
| 53 | 75 | 50 | 34 | 5 | 4 | 85 |
| 54 | 75 | 75 | 31 | 7 | 4.3 | 85 |
| 55 | 75 | 100 | 35 | 6 | 4.2 | 86 |
| 56 | 100 | 25 | 40 | 4 | 4.8 | 85 |
| 57 | 100 | 38 | 35 | 5 | 4.9 | 85 |
| 58 | 100 | 50 | 37 | 6 | 4.5 | 86 |
| 59 | 100 | 75 | 39 | 5 | 5 | 86 |
| 60 | 100 | 100 | 35 | 4 | 5 | 86 |

TABLE 4

| Comparative | Thickness of films | CTE | Re | | Y |
|---|---|---|---|---|---|
| Example | (μm) | (ppm/° C.) | (nm) | Y.I. | (D65) |
| 1 | 25 | 40 | 100 | 0.8 | 90 |
| 2 | 50 | 42 | 80 | 1 | 90 |
| 3 | 75 | 45 | 87 | 1.2 | 90 |
| 4 | 100 | 48 | 70 | 2 | 90 |
| 5 | 25 | 30 | 150 | 2.4 | 88 |
| 6 | 50 | 33 | 130 | 3 | 88 |
| 7 | 75 | 36 | 120 | 3.5 | 88 |
| 8 | 100 | 40 | 112 | 4.5 | 88 |
| 9 | 25 | 20 | 250 | 4.7 | 86 |
| 10 | 50 | 23 | 230 | 4.9 | 86 |
| 11 | 75 | 28 | 223 | 4.8 | 86 |
| 12 | 100 | 33 | 210 | 5 | 86 |

As shown in the tables, the polyimide films according to Examples 1 to 60 have dramatically low in-plane retardation (Re) values, compared to the polyimides films according to Comparative Examples 1 to 12, although there are some differences in values depending on the composition of the films, imidization ratios, thickness of the films, thickness of the substrate films, etc. Specifically, as for the polyimide films according to Comparative Examples 1 to 12, the lowest Rₑ value is 70 nanometers, and most Rₑ values are beyond 100 nanometers. For example, the films according to Comparative Examples 9 to 12, prepared from the polyamic acid solution according to Synthesis Example 3, have the Rₑ values of greater than 200 nanometers, while the maximum Rₑ of the films according to Examples 1 to 60, prepared from the polyamic acid solutions according to Synthesis Examples 1 to 3, is 10 nanometers.

The other properties, such as, CTE, YI, Y(D65), and the like of the films prepared according the Examples and Comparative Examples are similar.

Accordingly, it is noted that a polyimide film according to an embodiment has a significantly reduced in-plane retardation, while having excellent optical properties and thermal resistance. Thus, the polyimide film according to an embodiment is useful for the preparation of a substrate of a flexible display device.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A colorless transparent polyimide film having:
a thickness of about 1 micrometer to about 250 micrometers;
an average coefficient of thermal expansion measured in a machine direction and a transverse direction of less than or equal to about 80 parts per million/° C., measured using thermo-mechanical analyzer at a temperature range of 50° C. to 250° C. by a method comprising:
heating the film from 25° C. to 260° C. at a heating rate of 10° C./minute, cooling the film to 40° C. at a cooling rate of 10° C./min, and heating the film from 25° C. to 250° C. at a heating rate of 10° C./minute;
an average in-plane retardation of less than or equal to about 20 nanometers, measured by Axoscan at a wavelength of 550 nanometers throughout the area of the film;
an average Yellowness Index of less than or equal to 6, measured using a spectrophotometer, and
a transmittance for light at a wavelength of 370 nanometers to 740 nanometers of greater than or equal to about 80%, measured by using CIE standard, Illuminant D65.

2. The polyimide film according to claim 1, comprising:
a structure unit represented by Chemical Formula 1, a structure unit represented by Chemical Formula 2, or a combination thereof: 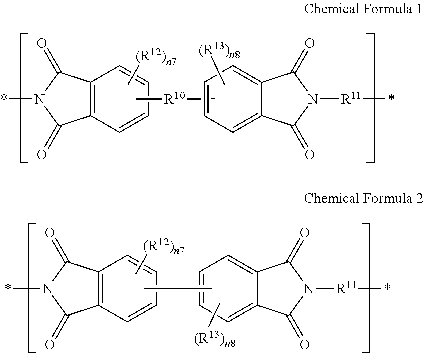
wherein in Chemical Formulae 1 or 2,
R¹⁰ is the same or different in each structure unit, and is independently a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic organic group,
R¹¹ is the same or different in each structure unit, and independently comprises a substituted or unsubstituted C6 to C30 aromatic organic group, wherein the aromatic organic group comprises one aromatic ring, two or more aromatic rings fused together to provide a condensed ring system, or two or more moieties independently selected from one aromatic ring and two or more aromatic rings fused together to provide a condensed ring system, which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH,
R¹² and R¹³ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and
n7 and n8 are each independently integers ranging from 0 to 3.

3. The polyimide film according to claim 2, wherein the structure unit represented by Chemical Formula 1 is represented by Chemical Formula 3: 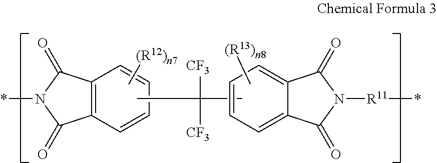
wherein in Chemical Formula 3,
R¹¹, R¹², R¹³, n7, and n8 are the same as in Chemical Formula 1.

4. The polyimide film according to claim 2, wherein R¹¹ is represented by Chemical Formula 4, Chemical Formula 5, or Chemical Formula 6: 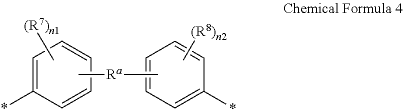
wherein in Chemical Formula 4,
R^{a} is selected from chemical formulae: 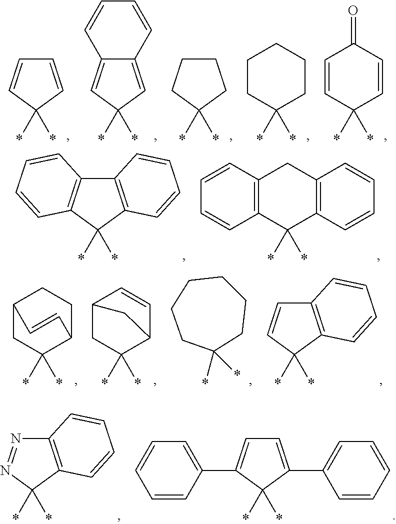
wherein in the chemical formulae,
R⁷ and R⁸ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and
n1 and n2 are each independently integers ranging from 0 to 4; 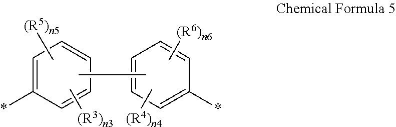
wherein, in Chemical Formula 5,
R³ and R⁴ are the same or different, and are independently electron withdrawing groups selected from —CF₃, —CCl₃, —CBr₃, —Cl₃, —NO₂, —CN, —COCH₃, and —CO₂C₂H₅,
R⁵ and R⁶ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and
n3 is an integer ranging from 1 to 4, n5 is an integer ranging from 0 to 3, provided that n3+n5 is an integer ranging from 1 to 4, and
n4 is an integer ranging from 1 to 4, n6 is an integer ranging from 0 to 3, provided that n4+n6 is an integer ranging from 1 to 4; and 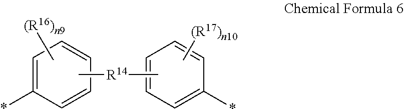
wherein in Chemical Formula 6,
R¹⁴ is O, S, C(═O), CH(OH), S(═O)₂, Si(CH₃)₂, (CH₂)ₚ wherein, 1≦p≦10, (CF₂)_{q} wherein, 1≦q≦10, C(CH₃)₂, C(CF₃)₂, C(═O)NH, or a substituted or unsubstituted C6 to C30 aromatic organic group, wherein the aromatic organic group comprises one aromatic ring, two or more aromatic rings fused together to provide a condensed ring system, or two or more moieties independently selected from one aromatic ring and two or more aromatic rings fused together to provide a condensed ring system, which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH,
R¹⁶ and R¹⁷ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and
n9 and n10 are each independently integers ranging from 0 to 4.

5. The polyimide film according to claim 2, wherein in Chemical Formulae 1 or 2, R¹¹ is represented by Chemical Formula 7, and both n7 and n8 are 0:

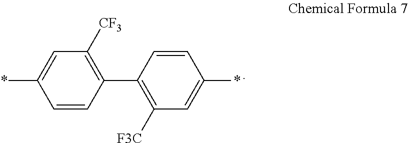 [SMILES: *c1ccc(-c2ccc(*)cc2C(F)(F)F)c(C(F)(F)F)c1]

6. The polyimide film according to claim 1, wherein the film comprises a structure unit represented by Chemical Formula 8, a structure unit represented by Chemical Formula 9, or a combination thereof:

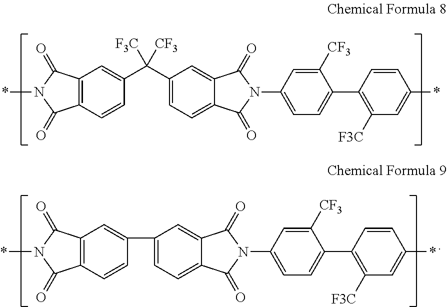

7. The polyimide film according to claim 2, wherein the film further comprises at least one of the structure unit represented by Chemical Formula 10, Chemical Formula 11, Chemical Formula 12, or a combination thereof: 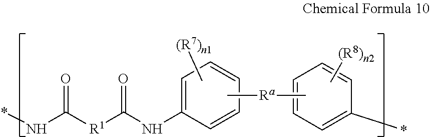
wherein in Chemical Formula 10,
R^{a}, R⁷, R⁸, n1, and n2 are the same as in Chemical Formula 4, and
R¹ is the same or different in each structure unit, and is independently a substituted or unsubstituted C6 to C30 aromatic organic group; 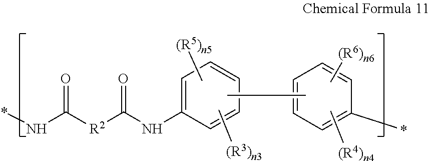
wherein in Chemical Formula 11,
R³, R⁴, R⁵, R⁶, n3, n4, n5, and n6 are the same as in Chemical Formula 5, and
R² is the same or different in each structure unit, and is independently a substituted or unsubstituted C6 to C30 aromatic organic group; and 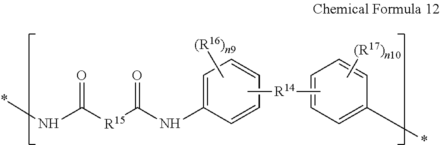
wherein in Chemical Formula 12,
R¹⁴, R¹⁶, R¹⁷, n9, and n10 are the same as described in Chemical Formula 6, and
R¹⁵ is the same or different in each structure unit, and is independently a substituted or unsubstituted C6 to C30 aromatic organic group.

8. The polyimide film according to claim 7, wherein in Chemical Formulae 10 to 12, R¹, R², and R¹⁵ are the same or different, and are independently selected from chemical formulae: 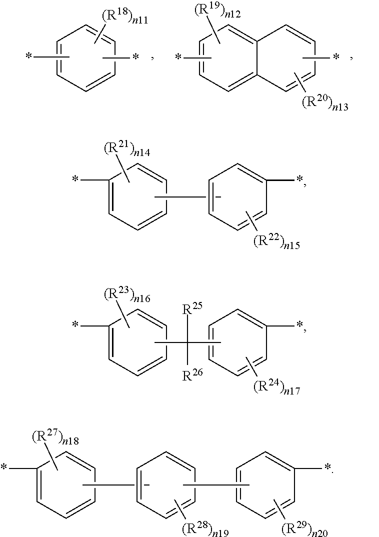
wherein in the chemical formulae,
R¹⁸ to R²⁹ are the same or different, and are independently deuterium, a halogen, a substituted or unsubstituted C1 to C10 aliphatic organic group, or a substituted or unsubstituted C6 to C20 aromatic organic group,
n11 and n14 to n20 are independently integers ranging from 0 to 4, and
n12 and n13 are independently integers ranging from 0 to 3.

9. The polyimide film according to claim 8, wherein R¹, R², and R¹⁵ are the same or different, and are independently selected from chemical formulae:

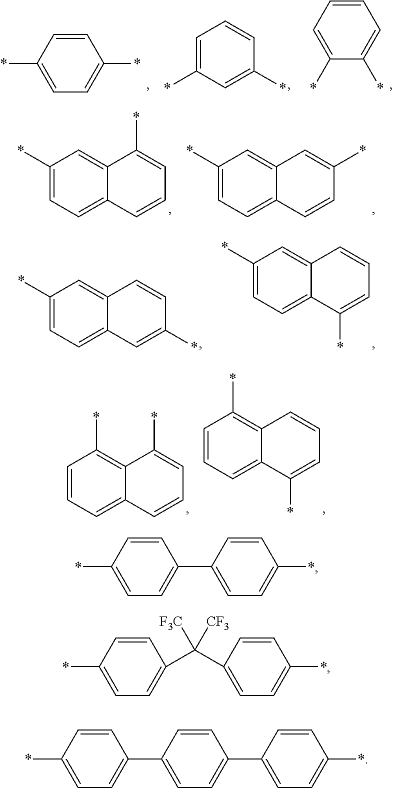

10. The polyimide film according to claim 7, wherein the structure unit represented by Chemical Formula 10 comprises a structure unit represented by Chemical Formulae 13, 14, 15, or a combination thereof, the structure unit represented by Chemical Formula 11 comprises a structure unit represented by Chemical Formulae 16, 17, 18, or a combination thereof, the structure unit represented by Chemical Formula 12 comprises a structure unit represented by Chemical Formulae 19, 20, 21, or a combination thereof:

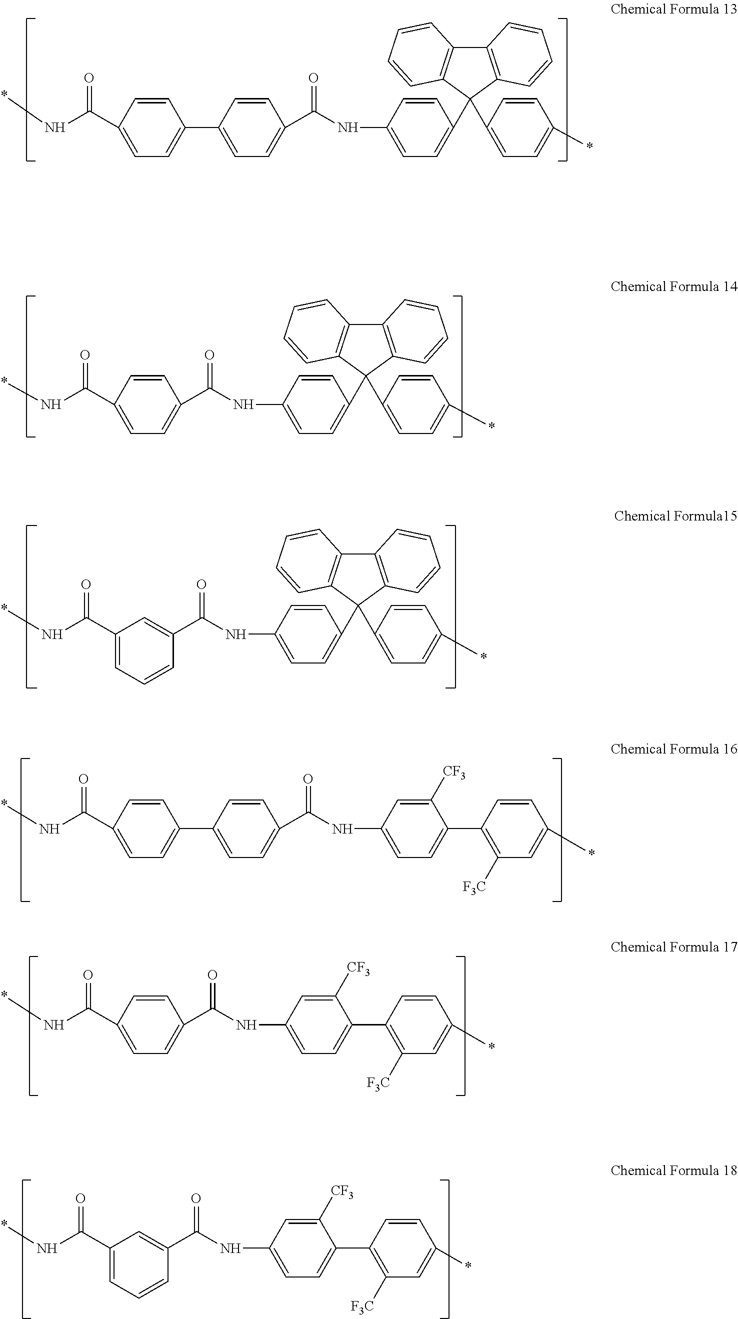

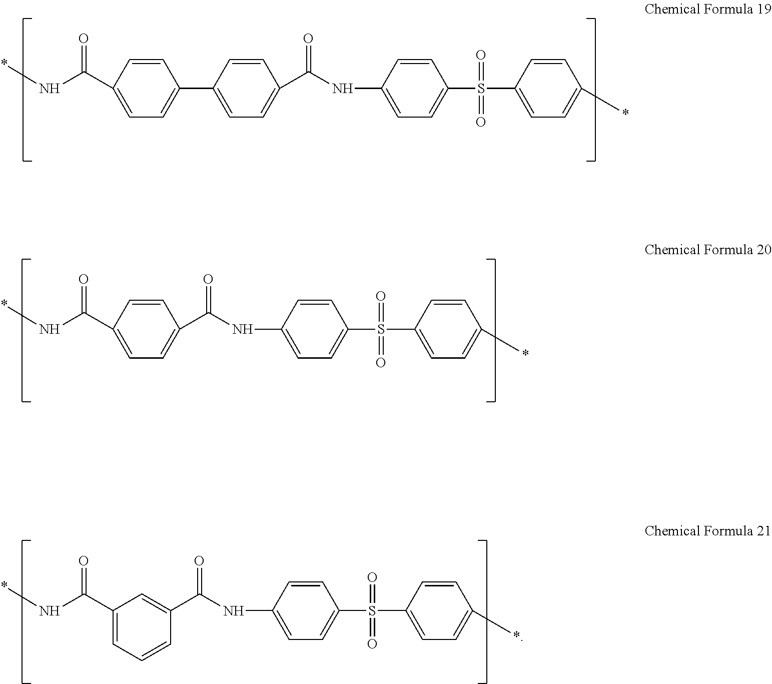

11. A method of preparing a colorless transparent polyimide comprising:
reacting at least one diamine selected from Chemical Formulae 22 to 24 with at least one dianhydride selected from Chemical Formulae 25 and 26 to provide a polyamic acid solution,
coating the polyamic acid solution on a surface of a polyimide-containing film, and heating to a temperature of less than 300° C. to form a polyamic acid layer on the polyimide-containing film,
heating and curing the polyamic acid layer on the polyimide-containing film to a temperature of less than 500° C. to form a polyimide film, and
separating the obtained polyimide film from the polyimide-containing film: 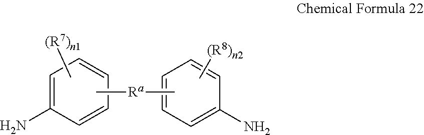
wherein in Chemical Formula 22,
R^{a} is selected from chemical formulae: 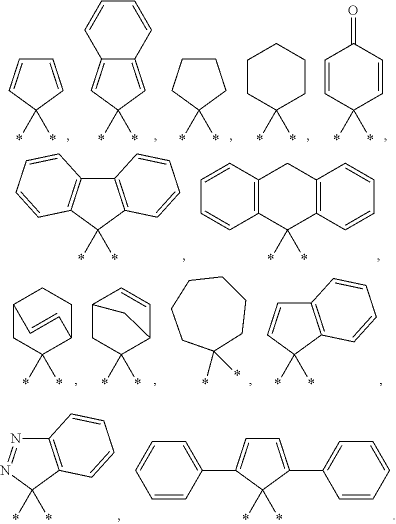
wherein in chemical formulae,
R⁷ and R⁸ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and
n1 and n2 are each independently integers ranging from 0 to 4; 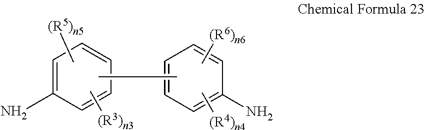
wherein in Chemical Formula 23,
R³ and R⁴ are the same or different, and are independently electron withdrawing groups selected from —CF₃, —CCl₃, —CBr₃, —Cl₃, —NO₂, —CN, —COCH₃, and —CO₂C₂H₅,
R⁵ and R⁶ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and
n3 is an integer ranging from 1 to 4, n5 is an integer ranging from 0 to 3, provided that n3+n5 is an integer ranging from 1 to 4, and
n4 is an integer ranging from 1 to 4, n6 is an integer ranging from 0 to 3, provided that n4+n6 is an integer ranging from 1 to 4; 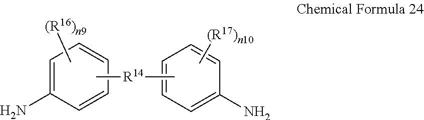
wherein in Chemical Formula 24,
R¹⁴ is O, S, C(═O), CH(OH), S(═O)₂, Si(CH₃)₂, (CH₂)ₚ wherein, 1≦p≦10, (CF₂)_{q} wherein, 1≦q≦10, C(CH₃)₂, C(CF₃)₂, C(═O)NH, or a substituted or unsubstituted C6 to C30 aromatic organic group, wherein the aromatic organic group comprises one aromatic ring, two or more aromatic rings fused together to provide a condensed ring system, or two or more moieties independently selected from one aromatic ring and two or more aromatic rings fused together to provide a condensed ring system, which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH,
R¹⁶ and R¹⁷ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and
n9 and n10 are each independently integers ranging from 0 to 4; 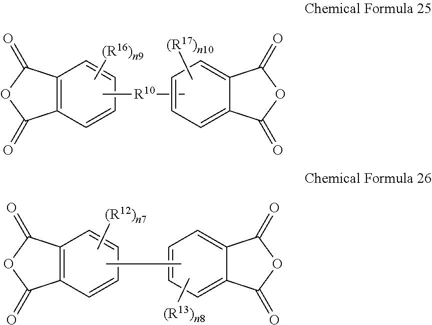
wherein in Chemical Formulae 25 or 26,
R¹⁰ is the same or different in each structure unit, and is independently a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic organic group,
R¹² and R¹³ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and
n7 and n8 are each independently integers ranging from 0 to 3.

12. The method according to claim 11, wherein the diamine is represented by Chemical Formula 23, wherein both R³ and R⁴ are —CF₃, both n3 and n4 are 1, and both n5 and n6 are 0.

13. The method according to claim 11, wherein the Chemical Formula 25 is represented by a structure unit represented by Chemical Formula 27: 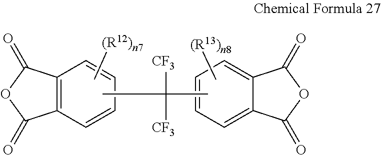
wherein in Chemical Formulae 27, R¹², R¹³, n7, and n8 are the same as in Chemical Formula 25.

14. The method according to claim 11, wherein the solid content in the polyamic acid solution is about 5 percent by weight to about 30 percent by weight, and the viscosity of the polyamic acid solution is about 1 poise to about 10,000 poise at 25° C.

15. The method according to claim 11, wherein the polyamic acid solution is partially imidized before coating on a surface of the polyimide-containing film.

16. The method according to claim 11, wherein the polyimide-containing film comprises a structure unit represented by Chemical Formula 1, a structure unit represented by Chemical Formula 2, or a combination thereof: 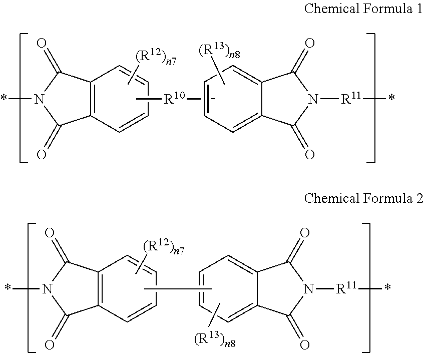
wherein in Chemical Formulae 1 or 2,
R¹⁰ is the same or different in each structure unit, and is independently a substituted or unsubstituted C1 to C30 aliphatic organic group, a substituted or unsubstituted C3 to C30 alicyclic organic group, a substituted or unsubstituted C6 to C30 aromatic organic group, or a substituted or unsubstituted C2 to C30 heterocyclic organic group,
R¹¹ is the same or different in each structure unit, and independently comprises a substituted or unsubstituted C6 to C30 aromatic organic group, wherein the aromatic organic group comprises one aromatic ring, two or more aromatic rings fused together to provide a condensed ring system, or two or more moieties independently selected from one aromatic ring and two or more aromatic rings fused together to provide a condensed ring system, which are linked through a single bond or through a functional group selected from a fluorenylene group, O, S, C(═O), CH(OH), S(═O)₂, Si(CH₃)₂, (CH₂)ₚ wherein 1≦p≦10, (CF₂)_{q} wherein 1≦q≦10, C(CH₃)₂, C(CF₃)₂, and C(═O)NH,
R¹² and R¹³ are the same or different, and are independently a halogen, a hydroxy group, a substituted or unsubstituted C1 to C10 aliphatic organic group, a substituted or unsubstituted C6 to C20 aromatic organic group, an alkoxy group of formula —OR²⁰⁸, wherein R²⁰⁸ is a substituted or unsubstituted C1 to C10 aliphatic organic group, or a silyl group of formula —SiR²⁰⁹R²¹⁰R²¹¹, wherein R²⁰⁹, R²¹⁰, and R²¹¹ are the same or different, and are independently hydrogen or a substituted or unsubstituted C1 to C10 aliphatic organic group, and
n7 and n8 are each independently integers ranging from 0 to 3.

17. The method according to claim 11, wherein the polyimide-containing film has a thickness of about 1 micrometer to about 1,000 micrometers.

18. The method according to claim 11, wherein the polyimide-containing film is UPILEX X film, which is a product of UBE Industries, Ltd.

19. The method according to claim 11, wherein the polyimide-containing film extends longitudinally, whereby the polyimide film prepared on the polyimide-containing film is separated from the polyimide-containing film in a roll-to-roll process.

20. An optical device comprising a polyimide film according to claim 1.
